(19) United States
(12) Patent Application Publication
(10) Pub. No.: US 2018/0024853 A1
(43) Pub. Date: Jan. 25, 2018

(54) METHODS, SYSTEMS, DEVICES AND APPLIANCES RELATING TO VIRTUALIZED APPLICATION-LAYER SPACE FOR DATA PROCESSING IN DATA STORAGE SYSTEMS

(71) Applicant: COHO DATA, INC., Santa Clara, CA (US)

(72) Inventors: Andrew WARFIELD, Vancouver (CA); Daniel FERSTAY, Vancouver (CA); JeanMaurice Guy GUYADER, Vancouver (CA); Jean-Sébastien Julien Benoit LEGARE, Vancouver (CA)

(21) Appl. No.: 15/549,983

(22) PCT Filed: Feb. 17, 2016
(86) PCT No.: PCT/US2016/018296

§ 371 Date: Aug. 9, 2017

Related U.S. Application Data
(60) Provisional application No. 62/117,032, filed on Feb. 17, 2015.

(51) Int. Cl. G06F 9/455

(52) U.S. Cl. CPC G06F 9/45558; G06F 2009/45591; G06F 2009/45579

(57) ABSTRACT

Described are various embodiments of methods, systems, devices and appliances relating to virtualized application-layer space for data processing in such data storage systems, including a distributed data storage system, and methods relating thereto, for implementing application-specific data processing of stored client data, the data storage system comprising: a plurality of communicatively coupled data storage components, each data storage component comprising at least one data storage resource and a processor, the plurality of data storage components maintaining a data object store of client data, said client data being stored in said data object store in accordance with a data object store file system; and a virtualized processing unit instantiated implementing application-specific data processing of said client data stored on the data object store, said client data object store accessible by said virtualized processing unit in accordance with an application-specific data storage access protocol.

### FIELD OF THE DISCLOSURE

The present disclosure relates to data storage systems, and, in particular, to methods, systems, devices and appliances relating to virtualized application-layer space for data processing in such data storage systems.

### BACKGROUND

In many data analysis processing systems, including those designed for processing and analyzing large-scale and unstructured datasets, such as Hadoop™, the datasets analysis processes are not closely coupled with the data storage systems where the data is being used (i.e. the commodity data storage system). In order to analyse the dataset, the data analysis system generates multiple copies which are copied to the data storage system. In general, multiple copies are generated, which are then divided into “chunks” of varying sizes and distributed in the local storage of the data analysis system. The main purpose for having multiple copies and distributing as chunks is to provide a failsafe (in case of failure of any storage device on which a copy of the dataset is being stored) as well as to increase performance (since different portions on different storage components of the same dataset can be analyzed (or accessed/retrieved/written/updated) in parallel—instead of in sequence).

As such, a dataset, upon which data analysis of datasets is conducted, requires copying to another data storage system that is local to the data analysis system, thus causing, particularly for large and unstructured datasets, increased inefficiency and resource waste. Moreover, since the dataset being analyzed is merely a copy of the actual data set, the dataset that is being analyzed is current only to the last migration of data since the true dataset may be continually being changed.

The above example relating to data analysis processing is one example of an application-layer processing space being de-coupled from commodity storage. Similar examples may apply in any other type of application-layer processing, such as processing by web servers or email servers, or any other type of application-layer processing requirements that may typically run on a dedicated server, including a virtualized processing unit, which may include a container (e.g. Linux Containers and Dockers™), jail (e.g. FreeBSD jail), virtual machine, virtualization engine, or OS virtualization (any of which may be referred to herein as virtualized processing units, or VPU). VPU have historically been de-coupled from storage because commodity storage processing power has been limited in very specific ways to manage storage and thus incapable of (or at least impractical or risky for) running application-layer processing directly at data storage.

One challenge in implementing data analysis application-layer processing, or indeed many other types of application-layer processes, directly on top of storage is that there are many applications which have developed their own application-layer processing requirements and data access protocols. For example, Hadoop uses HDFS (or Hadoop Distributed File System) which is specifically designed for analyzing very large sets of unstructured data quickly and safely. It is for this reason that data is usually copied and moved to alternative storage. Placing the application-layer processing directly into the storage facility currently requires a way for storage data management systems (e.g. a file system) to interface with application-layer processes. In the case of Hadoop, for example, HDFS is optimized for accessing and analyzing large amounts of unstructured data and is therefore specifically designed to be incapable of recognizing changes to data objects in the data store once they have been associated with a given data analysis. By making HDFS a read-only file system, certain efficiencies can be achieved. Since for storage-side data processing, the data store would have to exist in live data, and given that data analyses are not instantaneous (indeed, they may take a significant amount of time), there is a requirement for application-layer interfaces that will permit application-layer processes to run directly within dynamic data storage systems.

Legacy data storage systems have relied on inefficient data allocation and interaction, often with little or no processing power that cannot generally be used for more than responding to specific client requests. As most storage systems have been restricted to large banks of spinning disks, and more recently some hybridization of faster, but far more expensive, flash storage, the limitations of storage systems meant that high speed storage-side processing was unnecessary and/or redundant; data was placed on available storage according to data placement methodologies without regard to varying data storage performance and/or data performance requirements. Modern scalable and intelligent data storage systems are changing this limitation. As such, with the placement of additional processing power directly into storage and/or data interfaces therefor (e.g. SDN switching), this limitation is being removed. Coho Data™ Inc.'s scalable data storage systems are one example of such improvements. With the development of virtualization of both storage resources and processing power within a data storage facility, the utilization of data storage and associated processing power can be diverted to other functionalities or application-layer processing (e.g. Hadoop and other big data analysis platforms; virtualized web servers, data bases, email servers, etc.; and any other application-layer processing that may use data stored in such a data storage facility).

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for methods, systems, devices and appliances for data processing in data storage systems, for example relating to virtualized application-layer space, that overcome some of the drawbacks of known techniques, or at least, provide a useful alternative thereto. Some aspects of this disclosure provide examples of such methods, systems, devices and appliances.

For example, in accordance with some aspects, there are provided herein methods, systems, and devices for integrating application-specific processes for data processing in data storage systems to address this need. Some of these aspects provide for application-layer processing functionality that is not de-coupled from commodity data storage systems, and for data storage system integration with application-layer processing. That and other advantages will be disclosed herein.

In accordance with one embodiment, there is provided a data storage system configured to implement application-specific processing of data stored in the data storage system, the data storage system comprising at least one data storage component interfaceable with clients, each data storage component comprising at least one data storage resource and a processor, the said data storage components having instructions stored thereon configured to implement a VPU for application-layer processing of stored data, wherein data storage remains available for use by said clients during said processing.

In accordance with one embodiment, there is provided a distributed data storage system for implementing application-specific data processing of stored client data, the data storage system comprising a plurality of communicatively coupled data storage components, each data storage component comprising at least one data storage resource and a processor, the plurality of data storage components maintaining a data object store of client data, said client data being stored in said data object store in accordance with a data object store file system; and a virtualized processing unit instantiated on at least one of the processors and implementing application-specific data processing of client data stored on the data object store, said client data object store accessible by said virtualized processing unit in accordance with an application-specific data storage access protocol, wherein client data requests to the data object store can be processed by the data object store file system during application-specific data processing.

In accordance with another embodiment, there is provided a method of implementing application-specific processing in a distributed data storage system, the distributed data storage system comprising a plurality of communicatively coupled data storage components, each data storage component comprising at least one data storage resource and a processor, the plurality of data storage components maintaining a data object store of client data, said client data being stored in said data object store in accordance with a data object store file system, the method comprising: Instantiating a virtualized processing unit on at least one of the processers; Implementing on the virtualized processing unit an application for application-specific data processing of client data stored on the data object store; and Accessing client data in the data object store in accordance with an application-specific data access protocol while client data requests to the data object store can be processed by the data object store file system.

In accordance with another embodiment, there is provided a data storage device for implementing application-specific data processing of stored client data in a distributed data storage system, the data storage component comprising at least one data storage resource, a processor, and communications interface for network communication with at least one of the following: one or more clients and other data storage devices; wherein the data storage device maintains at least a portion of client data in a data object store, said client data being stored in said data object store in accordance with a data object store file system; and wherein the data storage device is configured to instantiate thereon a virtualized processing unit , the virtualized processing unit configured to implement application-specific data processing of client data in the data object store, said client data object store accessible by said virtualized processing unit in accordance with an application-specific data storage access protocol, wherein client data requests to the data object store can be processed by the data object store file system during application-specific data processing.

In accordance with one embodiment, there is provided method of integrating a data object store file system of a data storage system with an application-specific data access protocol, the application-specific data access protocol being implemented by an application-specific process in a virtualized processing unit in the data storage system, the method comprising: optionally, implementing or making available a namespace mapping of storage locations of data objects in the data object store; exposing the application-specific data access protocol as a direct interface to the data storage system; translating from application-specific data access protocol requests to requests in the underlying data object store file system; and optionally rectifying any incompatibilities between the application-specific data access protocol and the underlying data object store file.

Existing systems may seek to implement VPU onto systems which are created and designed to implement application-layer processes, for example, such as Hadoop™. In general, Hadoop copies and replicates large data sets from an enterprise data store to a Hadoop-specific data storage system and then implements a VPU thereon to conduct the data analysis of the copied and replicated data set. Embodiments herein provide for implementing application layer processes, such as Hadoop™, into VPU running directly on the enterprise data storage system. This permits the use of live or highly current data and saves resources from additional storage, as well as the network bandwidth for copying, replicating, and maintaining namespace for the dataset under analysis. Moreover, the ability to prioritize and deprioritize VPU processes (and request traffic) relative to data storage processes (or indeed other VPU processes) becomes possible when the VPU exists directly within the commodity data storage system capable of prioritizing processes. Particularly with data analysis systems such as Hadoop™, which is intended for processing extremely large and unstructured datasets, generally in batch processing, significant efficiency is gained by directly coupling such application-layer processing directly onto the data storage system via a VPU.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1A is a schematic diagram of a computing device showing distinctions between physical computing devices, VPUs which are virtual machines, and other VPU, such as containers, in accordance with one embodiment;

FIG. 1B is a schematic diagram of a computing device supporting a plurality of virtual machines, in accordance with one embodiment;

FIG. 1C is a schematic diagram of a computing device supporting VPU containers, in accordance with one embodiment;

FIG. 2 is a schematic diagram of a conventional Hadoop architecture and processes;

FIG. 3 is a schematic diagram of a data storage system architecture, in accordance with one embodiment; and

FIG. 4 is a diagram of a data object store in association with various VPUs, in accordance with one embodiment.

### DETAILED DESCRIPTION

In some embodiments there are provided methods, devices and systems for application-specific data processing directly on storage nodes in a data storage system by conducting such processing in virtualized processing units (in some exemplary embodiments, a container or docker™) instantiated directly on storage-side processors within the data storage system where live client data is stored. The virtual processing units utilize available processing, memory and data storage resources in the data storage system for implementing application-specific processing of stored data within the data storage system (and without, for example, moving such data to a separate system for the data analysis). Some embodiments may include a data storage system, comprising of inter-connected data storage components and, in some cases, a switching component acting as an interface between the data storage system and process-related clients, wherein application program interfaces (APIs) are installed and run on the constituent data storage components and/or the switching components. Such APIs provide for the instantiation and use of virtual processing units on the data storage components and thusly provide for a distributed run-time environment for implementing application-layer processing capabilities on top of a data storage system. In some embodiments, significant data processing capacity is required within modern storage systems to handle periods of high levels of data storage activity (e.g. writing and reading data, pre-fetching and/or demoting data to appropriate storage, handling device malfunction, etc.); embodiments herein may leverage such processing capacity during periods when there is available processing capacity (e.g. between periods of high data storage processing activity) to facilitate data processing of current and live data, and without wasting time and resources to copy, store, and manage a separate application-specific data object storage facility. Such embodiments may provide a way to utilize available processing capacity within the data storage facility itself.

In some modern data storage systems, there may be significant processing capability in the data storage system that is generally used for maintaining and managing a data object store of client and other related data and responding to client data requests (i.e. reads and writes). Storage processing and IO limits associated with data storage systems, in order to ensure that the system maintains practicable operation at all times, must be reflective of processing or IO demands during maximal or peak periods. During non-peak periods such processing and/or IO resources may remain available but unused. By implementing storage-side application-specific processing, the utilization of such available resources is greatly increased and the data used for such processing is current and localized. Moreover, the data used by the application-specific processes is permitted to share in the benefits of advanced storage systems that may have been implemented to increase performance characteristics for stored client data; such characteristics may include increased and customizable latency and throughput performance, security and reliability, scalability, prioritization and de-prioritization (e.g. through pre-fetching and utilization of dark or “cold” storage for hot and cold data respectively), and efficient dynamic placement of data on various data storage tiers based on characteristics associated with the data, the data client, and the applicable processing of the data. The placement is dynamic because the characteristics may indicate changes in priority over time, possibly relative to other data and/or data clients and/or data processes (which may also be associated with dynamic changes in priority). The available processing power in embodiments may be used for non-data storage processing purposes, including but not limited to data analysis of the stored data (e.g. Hadoop), web services (e.g. acting as a web server), back-up services, virus checking, database services (e.g. SQL server), garbage collection, smart compression, and other application-specific and/or administrative services. By implementing a VPU directly on top of such storage-side resources, in addition to other advantages disclosed or made apparent hereinbelow, the available processing power is leveraged and the access to current and live client data is facilitated.

In some embodiments, the data storage systems comprise of at least one data storage component, wherein the data storage component comprises at least one physical data storage resource and at least one data processor; in some embodiments, the data storage systems may further comprise a switching component for interfacing the at least one data storage components with data clients, possibly over a network. In embodiments, a plurality of data storage components can operate together to provide distributed data storage wherein a data object store is maintained across a plurality of data storage resources and, for example, related data objects, or portions of the same data object can be stored across multiple different data storage resources. By distributing the data object store across a plurality of resources, there may be an improvement in performance (since requests relating to different portions of a set of client data, or even a data object, can be made at least partially in parallel) and in reliability (since failure or lack of availability of hardware in most computing systems is possible, if not common, and replicates of data can be placed on different hardware). Recent developments have seen distributed data storage systems comprise of a plurality of scalable data storage resources, such resources being of varying cost and performance within the same system. This permits, for example through the use of SDN-switching and higher processing power storage components, an efficient placement of storage of a wide variety of data having differing priorities on the most appropriate data storage tiers at any given time: “hot” data (i.e. higher priority) is moved to higher performing data storage (which may sometimes be of relatively higher cost), and “cold” data (i.e. lower priority) is moved to lower performing data storage (which may sometimes be of lower relative cost). Depending on the specific data needs of a given organization having access to the distributed data storage system, the performance and capacity of data storage can scale to the precise and customized requirements of such organization. Such systems have processing power by increasing and customizing “storage-side” processing. By implementing virtualized processing units on the storage side, a high degree of utilization of the processing power of storage-side processors becomes possible, putting processing “closer” to live data.

In some embodiments, a data storage component may include both physical data storage components, as well as virtualized data storage components instantiated within the data storage system (e.g. a VM). Such data storage components may be referred to as a data storage node, or, more simply, a node. A data storage component may be instantiated by or on the one or more data processors as a virtualized data storage resource, which may be embodied as one or more virtual machines (hereinafter, a “VM”), virtual disks, or containers. The nodes, whether physical or virtual, operate together to provide scalable and high-performance data storage to one or more clients. The distributed data storage system may in some embodiments present, what appears to be from the perspective of client (or a group of clients), one or more logical storage units; the one or more logical storage units can appear to such client(s) as a node or group of nodes, a disk or a group of disks, or a server or a group of servers, or a combination thereof. Such logical unit(s) may in fact be a physical data storage component or a group thereof, a virtual data storage component or group thereof, or a combination thereof. The nodes and, if present in an embodiment, the switching component, work cooperatively in an effort to maximize the extent to which available data storage resources provide storage, replication, customized access and use of data, as well as a number of other functions relating to data storage. In general, this is accomplished by managing data through real-time and/or continuous arrangement of data (which includes allocation of storage resources for specific data or classes or groups of data) within the data object store, including but not limited to by (i) putting higher priority data on lower-latency and/or higher-throughput data storage resources; and/or (ii) putting lower priority data on higher-latency and/or lower-throughput data storage resources; and/or (iii) co-locating related data on, or prefetching related data to, the same or similar data storage resources (e.g. putting related data on higher or lower tier storage data from the object store, where “related” in this case means that the data is more likely to be used or accessed at the same time or within a given time period); and/or (iv) re-locating data to, or designating for specific data, “closer” or “farther” data storage (i.e. where close or far may refer to the number of network hops, or more generally, the availability of data when requested and the latency and/or throughput of such requests and responses thereto) depending on the priority of the data; and/or (v) replicating data for performance and reliability and, in some cases, optimal replica selection and updating for achieving any of the aforementioned objectives.

In some embodiments, with no, little, or controllable/tuneable impact on the ability to manage the data object store for storing client data, or respond to client data requests, the virtual containers (or other type of virtualized processing unit) utilize the processing capability of the processors of the data storage components to carry out data processing directly on the data stored in the data storage system, even while the availability of the data object store is maintained for data clients.

In general, each data storage component comprises one or more storage resources and one or more processing resources for maintaining some or all of a data object store and/or responding to data requests for data in the data object store. In some embodiments, a data storage component may also be communicatively coupled to one or more other data storage components, wherein the two or more communicatively coupled data storage components cooperate to provide distributed data storage. In some embodiments, such cooperation may be facilitated by a switching component, which in addition to acting as an interface between the data object store maintained by the data storage component(s) and any clients or the network on which the clients access the data store. The switching interface may direct data requests/responses efficiently, and also in some embodiments dynamically allocate storage resources for specific data in the data object store.

In some embodiments, there is provided a distributed data storage system for implementing application-specific data processing of stored data, the data storage system comprising a plurality of communicatively coupled data storage components for maintaining a data object store of client data, each data storage component comprising at least one data storage resource and a processor, said data storage components configured to implement a virtualized processing unit, said virtualized processing unit running on at least one of the processors and being configured to process client data in the data object store, wherein said data object store remains available for data storage and client data requests during data processing by said virtualized processing unit.

In some embodiments, there is provided a distributed data storage system for implementing application-specific data processing of stored client data, the data storage system comprising a plurality of communicatively coupled data storage components, each data storage component comprising at least one data storage resource and a processor, the plurality of data storage components maintaining a data object store of client data, said client data being stored in said data object store in accordance with a data object store file system; and a virtualized processing unit instantiated by at least one of the processors and implementing application-specific data processing of client data stored on the data object store, said client data object store accessible by said virtualized processing unit in accordance with an application-specific data storage access protocol, wherein client data requests to the data object store can be processed by the data object store file system during application-specific data processing. In some embodiments, the foregoing system may also comprise an integration module for communicating client data changes in the data object store, which may result from client data requests, to the virtualized processing unit during application-specific data processing of client data. In some embodiments, the data object store file system of one or more of the foregoing embodiments is configured to implement client data changes in the data object store resulting from application-specific data requests resulting from the application-specific data processing in the virtualized processing unit.

In embodiments, a client of the system may request data analysis processing, or indeed any type of application-specific processing, of data associated with the data storage system. In embodiments, the data storage system either instantiates a virtualized processing unit or uses a previously instantiated virtualized processing unit which can be run (or is running, as the case may be) directly on one or more of the processors of the data storage components. The virtualized processing unit (sometimes referred to as a VPU herein) uses the data processing resources available across the some or all data storage components upon which it has been instantiated; examples of the VPU may include a container, a VM, or any virtualized storage and/or processing and/or communications resource. The VPU maintains access with the data storage components (i.e. nodes) upon which such VPU has been instantiated, or indeed from some or all of the nodes across the data storage system via communicative connections therebetween, and performs application-specific processing on the data in the data object store of the data storage system. The data storage system remains available for data storage functionality while increasing the utilization of the processing power available in the data storage components.

In some embodiments, the virtualized processing unit may be any emulation of a computer system or aspect thereof by one or more physical computing systems. The emulated computer system, or aspect thereof, may appear and provide the same functionality as the physical computer system, or aspect thereof, which is being emulated. For example, a VM emulates a computing device; while it is instantiated and run on a physical computing device, it may appear to other nodes (or indeed a client) on a common network to be a physical computer. If the physical computing device(s) on which the emulated computer system, or aspect thereof, were to fail or cease to operate, however, the emulation would no longer be available unless the processes that maintained the emulation were passed to one or more other physical computing devices that remained available. Different VPUs may emulate some or all aspects of the underlying physical computing system; for example, a VM is an emulation of a server or computer; a container is an emulation of user space via namespace isolation (which may in fact appear to clients or other nodes as a VM); a VPN is an emulation of a private network or “tunnel”; a jail is an operating system-level virtualization for partitioning specific computing systems into independent mini-systems. The VPU is configured to implement application-specific processing, such as but not limited to data analysis, data, web or networking services, or other administrative maintenance. Any application may be run by or within the VPU; such applications may be used for processing data, some of which may be sourced or associated with a data object store maintained by the data storage system.

As used herein, the term “virtual,” as used in the context of computing devices, may refer to one or more computing hardware or software resources that, while offering some or all of the characteristics of an actual hardware or software resource to the end user, is an emulation of such a physical hardware or software resource that is instantiated upon physical computing resources. Virtualization may be referred to as the process of, or means for, instantiating emulated or virtual computing elements such as, inter alio, hardware platforms, operating systems, memory resources, network resources, hardware resource, software resource, interfaces, protocols, or other element that would be understood as being capable of being rendered virtual by a worker skilled in the art of virtualization. Virtualization can sometimes be understood as abstracting the physical characteristics of a computing platform or device or aspects thereof from users or other computing devices or networks, and providing access to an abstract or emulated equivalent for the users, other computers or networks, wherein the abstract or emulated equivalent may sometimes be embodied as a data object or image recorded on a computer readable medium. The term “physical,” as used in the context of computing devices, may refer to actual or physical computing elements (as opposed to virtualized abstractions or emulations of same).

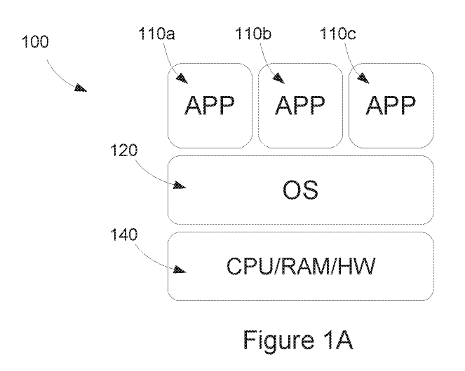

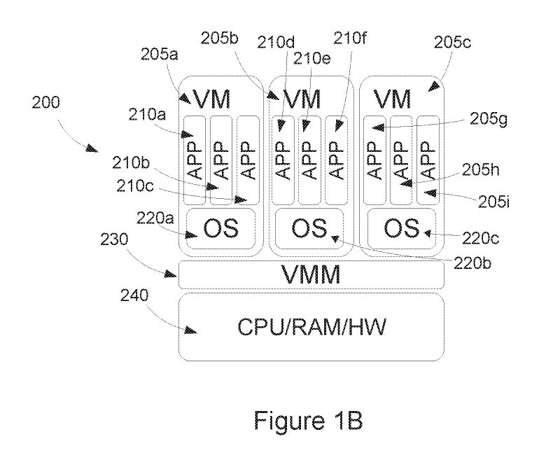

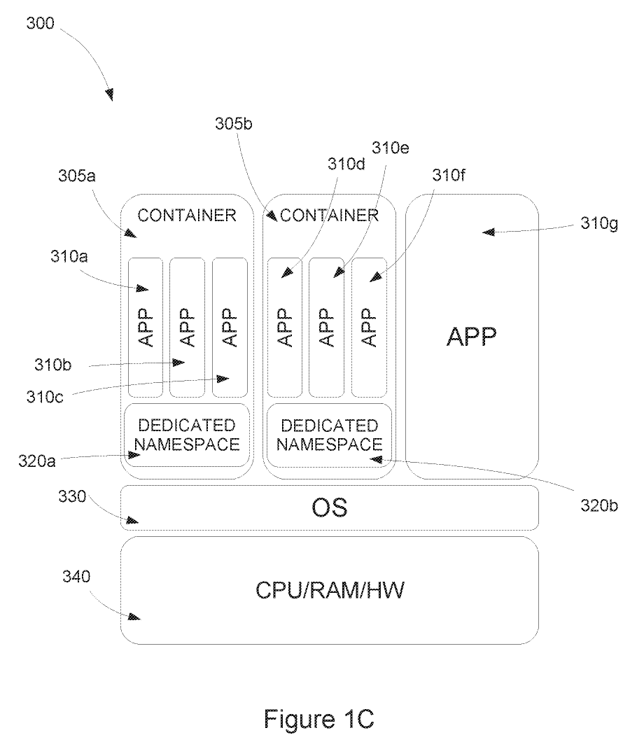

With reference to FIG. 1A, a standard computing device 100 is shown to illustrate the distinctions between physical computing devices, VPU which are virtual machines, and other VPU, such as containers. The computing device 100 is shown as an abstraction of some of its constituent aspects, including the hardware layer 140, which includes the CPU (or processor), the memory (e.g. RAM), data storage (e.g. disks), and other hardware. Above the hardware layer, an operating system 120 exposes various APIs (application programming interfaces) and/or system call functions that are used by application-layer functions, such as the applications 110A, 110B and 110C at the application-layer to interface with the computing hardware and cause it to carry out application-layer instructions.

With reference to FIG. 1B, a computing device 200 is shown to support a plurality of virtual machines 205A, 205B, 205C (a virtual machine may sometimes be referred to herein as a VM). In some embodiments, a VM may be used to support a storage node (i.e. a virtual data storage component) and in some cases it may also be used to support a VPU. In some embodiments where the VPU is a virtual machine, the underlying computing device may utilize a virtual machine monitor (VMM) 230, which in some cases may be called a hypervisor, that overlays the computing hardware 240 associated with the computing device 200 on which VMs 205A, 205B, 205C are running. The VMM 230 intermediates between virtual machines 205A, 205B, 205C and their respective operating systems 220A, 220B, 220C, which permits virtual machines to run their own applications 210A through 210I, and operating systems 220A, 220B, 220C while being completely isolated from one another, but still able to share—and thus greatly increase utilization of—physical hardware 240. In some embodiments, not shown in FIG. 1B, there is yet another intermediation between the OS and the VMM, wherein an appliance facilitates interoperability of VMMs on different machine. In such embodiments, VMs may be running on any one of the processors in one of the data storage components in the distributed storage system and be given access to the processing, memory, networking and data storage resources of any other data storage component; in such an embodiment, the appliance intermediates between VMMs that interface the hardware on any of the plurality of data storage components.

With reference to FIG. 1C, a computing device 300 is shown for supporting VPUs that are containers 305A, 305B. In this embodiment, the VPU 305A, 305B may be instantiated on computing hardware 340 which directly exposes the VPU 305A, 305B to the OS 330 running on the computing device; the container-type VPU 305A, 305B is configured, via a dedicated namespace 320A, 320B to have namespace isolation with respect to, and isolated management of, aspects computing devices, including but not limited to the OS itself, the hardware, and the file system and networking functionalities of the computing device. As such, a container-type VPU, while not having its own completely independent OS, instead has dedicated resources of the computing device that are capable of running its own applications 310A, 310B, 310C, 310D, 310E, 310F isolated from other containers, VPUs, VMs, or other applications 330G running on the device 300. Each container may be described as having access to and control over a “shared nothing”; that is, the domain of each the container relates to a set of computing resources that may be shared with other containers, but is isolated therefrom by virtue of having a dedicated namespace in respect of a portion or aspects of those resources.

In other embodiments, these and other types of VPUs may be instantiated. Instantiation may refer to the process of creating or running an instance of a VPU on a computing device (including the data storage components or the switching component of the distributed data storage system). Instantiation may also be characterized as the realization of a VPU, rather than the description or set of instructions relating to the characteristics or operation of the VPU; initiating at run-time a VPU on the basis of the description and/or set of instructions relating the characteristics or operation of the VPU may be considered to be instantiation. In some embodiments, the VPU may be any emulated instance of a computing resource, or aspect thereof, that is capable of processing information or instructions, including but not limited to data requests, data units, application-specific instructions, file-system requests, networking instructions, or any other information or requests that a physical computing resource or aspect thereof is capable of processing.

In embodiments, a data storage component comprises at least one data storage resource and a processor. In embodiments, a data storage component may comprise one or more enterprise-grade PCIe-integrated components, one or more disk drives, a CPU and a network interface controller (NIC). In embodiments, a data storage component may be described as balanced combinations of, as exemplary sub-components, PCIe flash, one or more 3 TB spinning disk drives, a CPU and 10 Gb network interface that form a building block for a scalable, high-performance data path. In embodiments, the CPU also runs a storage hypervisor which allows storage resources to be safely shared by multiple tenants, over multiple protocols. In some embodiments, in addition to generating virtual memory resources from the data storage component on which the hypervisor is running, the hypervisor may also be in data communication with the operating systems on other data storage component in the distributed data storage system, and can present virtual storage resources that utilize physical storage resources across all of the available data resources in the system. The hypervisor or other software on the data storage components and the optional switching component may be utilized to distribute a shared data stack. In embodiments, the shared data stack comprises a TCP connection with a data client, wherein the data stack is passed between or migrates from data server to data server. In embodiments, the data storage component can run software or a set of other instructions that permit the component to pass the shared data stack amongst itself and other data storage components in the data storage system; in embodiments, the network switching device also manages the shared data stack by monitoring the state, header, or content (i.e. payload) information relating to the various protocol data units (PDU) passing thereon and then modifies such information, or else passes the PDU to the data storage component that is most appropriate to participate in the shared data stack (e.g. because the requested data is stored at that data storage component).

In embodiments, the storage resources are any computer-readable and computer-writable storage media. In embodiments, a data storage component may comprise a single storage resource; in alternative embodiments, a data storage component may comprise a plurality of the same kind of storage resource; in yet other embodiments, a data server may comprise a plurality of different kinds of storage resources. In addition, different data storage components within the same distributed data storage system may have different numbers and types of storage resources thereon. Any combination of number of storage resources as well as number of types of storage resources may be used in a plurality of data storage components within a given distributed data storage system without departing from the scope of the instant disclosure. Exemplary types of memory resources include memory resources that provide rapid and/or temporary data storage, such as RAM (Random Access Memory), SRAM (Static Random Access Memory), DRAM (Dynamic Random Access Memory), SDRAM (Synchronous Dynamic Random Access Memory), CAM (Content-Addressable Memory), or other rapid-access memory, or more longer-term data storage that may or may not provide for rapid access, use and/or storage, such as a hard disk drive, flash drive, optical drive, SSD, other flash-based memory, PCM (Phase change memory), or equivalent. Other memory resources may include uArrays, Network-Attached Disks and SAN.

In embodiments, data storage components, and storage resources therein, within the data storage system can be implemented with any of a number of connectivity devices known to persons skilled in the art, even if such devices did not exist at the time of filing, without departing from the scope and spirit of the instant disclosure. In embodiments, flash storage devices may be utilized with SAS and SATA buses (˜600 MB/s), PCIe bus (˜32 GB/s), which support performance-critical hardware like network interfaces and GPUs, or other types of communication system that transfers data between components inside a computer, or between computers. In some embodiments, PCIe flash devices provide significant price, cost, and performance trade-offs as compared to spinning disks. The table below shows typical data storage resources used in some exemplary data servers.

| | Capacity | | Throughput | | Latency | | Power | Cost |
|---|---|---|---|---|---|---|---|---|
| 15K RPM | 3 | TB | 200 | IOPS | 10 | ms | 10 W | $200 |
| Disk | | | | | | | | |
| PCIe Flash | 800 | GB | 50,000 | IOPS | 10 | μs | 25 W | $3000 |

In embodiments, PCIe flash may be about one thousand times lower latency than spinning disks and about 250 times faster on a throughput basis. This performance density means that data stored in flash can serve workloads less expensively (as measured by 10 operations per second; 16× cheaper by IOPS) and with less power (100× fewer Watts by IOPS). As a result, environments that have any performance sensitivity at all should be incorporating PCIe flash into their storage hierarchies (i.e. tiers). In an exemplary embodiment, specific clusters of data are migrated to PCIe flash resources at times when these data clusters have high priority (i.e. the data is “hot”), and data clusters having lower priority at specific times (i.e. the data clusters are “cold”) are migrated to the spinning disks. In embodiments, performance and relative cost-effectiveness of distributed data systems can be maximized by either of these activities, or a combination thereof. In such cases, a distributed storage system may cause a write request involving high priority (i.e. “hot”) data to be directed to available storage resources having a high performance capability, such as flash (including related data, which may be requested or accessed at the same or related times and can therefore be pre-fetched to higher tiers); in other cases, data which has low priority (i.e. “cold”) is moved to lower performance storage resources (likewise, data related data to the cold data may also be demoted). In both cases, the system is capable of cooperatively diverting the communication to the most appropriate storage node(s) to handle the data for each scenario. In other cases, if such data changes priority, some or all of it may be transferred to another node (or alternatively, a replica of that data exists on another storage node that is more suitable to handle the request or the data at that time may be designated for use at that time), the switch and/or the plurality of storage nodes can cooperate to participate in a communication that is distributed across the storage nodes deemed by the system as most optimal to handle the response communication; the client may, in embodiments, remain unaware of which storage nodes are responding or even the fact that there are multiple storage nodes participating in the communication (i.e. from the perspective of the client, it is sending client requests to, and receiving client request responses from a single logical data unit). In some embodiments, the nodes may not share the distributed communication but rather communicate with each other to identify which node could be responsive to a given data request and then, for example, forward the data request to the appropriate node, obtain the response, and then communicate the response back to the data client.

In some embodiments, there may be provided a switching component that provides an interface between the data storage system and the one or more data clients, and/or clients requesting data analysis (or other application-layer processing). In some embodiments, the switching component can act as a load balancer for the nodes and the VPUs, between VPUs, or between any data storage processes and VPUs so as to distribute requests relating thereto to the most appropriate nodes for processing. In some embodiments, the switching component selects the least loaded VPU. In other cases, the nodes themselves may determine that VPU should be offloaded to processing resources on other nodes and can then pass the shared connection to the appropriate nodes. In some exemplary embodiments, the switching component uses OpenFlow™ methodologies to implement forwarding decisions relating to data requests or other client requests. In some embodiments, there are one or more switching components which communicatively couple data clients with data storage components. Some switching components may assist in presenting the one or more data servers as a single logical unit; for example, as one or more virtual NFS servers for use by clients. In other cases, the switching components also view the one or more data storage components as a single unit with the same IP address and communicates a data request stack to the single unit, and the data storage components cooperate to receive and respond to the data request stack amongst themselves. In some cases, the network switching devices may be referred to herein as “a switch.”

Exemplary embodiments of network switching devices include, but are not limited to, a commodity 10 Gb Ethernet switching device as the interconnect between the data clients and the data servers; in some exemplary switches, there is provided at the switch a 52-port 10 Gb Openflow-Enabled Software Defined Networking (“SDN”) switch (and supports 2 switches in an active/active redundant configuration) to which all data storage components (i.e. nodes) and clients are directly or indirectly attached. SDN features on the switch allow significant aspects of storage system logic to be pushed directly into the network in an approach to achieving scale and performance. In aspects of the instantly described subject matter, communications resources may be considered when instantiating a given VPU for storage-side data processing. For example, given two or more data storage components, each having similar data storage and data processing resources, in terms of performance, capacity, and workload, the system may cause instantiation of (or transfer an existing) VPUs on the data storage component(s) having the higher performing data communications resources. In some cases, the NIC on a given data storage component may be responding to data read requests by serving up very large amounts of data, and therefore have a backlog or be otherwise overloaded; even though the data storage and/or data processing resources may be available (or have similar performance availabilities), the storage-side processing (or other application-layer requirement) may be better suited by associating the VPU with the data storage component with the best or most responsive communications resources. Other examples, may include the component with the highest performing network interface hardware, or the fewest number of network nodes between the client and the component or the component instantiating the VPU and those components on which the data is stored.

In embodiments, the one or more switches may support network communication between one or more clients and one or more data storage components. In some embodiments, there is no intermediary network switching device, but rather the one or more data storage components operate jointly to handle client requests and/or data processing. An ability for a plurality of data storage components to manage, with or without contribution from the network switching device, a distributed data stack contributes to the scalability of the distributed storage system; this is in part because as additional data storage components are added they continue to be presented as a single logical unit (e.g. as a single NFS server) to a client and a seamless data stack for the client is maintained. Conversely, the data storage components and/or the switch may cooperate with each other to present multiple distinct logical storage units, each of such units being accessible and/or visible to only authorized clients.

The data object store may refer to the set or sets of data and/or data objects that is/are being stored within the data storage system. It may include both the structure and organization of that data, such as the file system hierarchies, address space, routing/mapping structures for data requests, and the organization of the data. A data object store is not necessarily limited to object-oriented data structures or abstractions; it may include other structures and abstractions, such as data in a relational database or a file-oriented store. A data storage system may comprise of a plurality of data object stores, each of which may be used or exist for the benefit of a plurality of clients, users and/or organizations. The data object store may also refer to the entire set of data and/or its organization within a given data storage system. In some embodiments, the distributed data storage system is comprised of a plurality of data object stores that coordinate to replicate data and spread load across some or all nodes in the system. Distributed data storage systems described herein may not be limited to systems having a single data object store.

In some embodiments, the data object store may be organized, managed and interfaced with in accordance with a data object store file system. In some embodiments, the data object store file system is a distributed file system capable of being implemented to enable organization, management and interfacing with a distributed set of data storage components. In some cases, the data object store file system may include NFS (or Network File System), to the extent that it is further configured (including through interoperation with additional software, file systems, instructions or other intermediaries) to permit organization, management and interfacing of data across a distributed data storage system. Other file systems known in the art are possible, and may include disk file systems (e.g. AFS, BFS, ext, FAT, HFS, NTFS, UFS, among others known to persons skilled in the art), file-oriented systems, block-oriented or object-oriented file systems, record-oriented file systems, file systems optimized for specific media such as flash or tape (e.g. CASL, exFAT, ExtremeFFS, F2FS, JFFS, WAFL, VMFS, and others known to persons skilled in the art), database file systems (where files may be organized in accordance with their metadata characteristics), minimal file systems, shared disk file systems, transactional file systems, and distributed file systems (e.g. NFS, Amazon S3, AFP, FAL, NCP, DCE/DFS, among others known to persons skilled in the art). NFS may be used in some embodiments, which is a file system protocol for distributed file systems that permits a client to access a file system via a network. In general, the data object store file system is used to control how data is stored and retrieved by and within the data object store; file systems may, for example, provide information and structure relating to how and where information placed in a storage area is located (or which specific portions of storage are associated with specific data) and how requests for such data are serviced. In general, the file system is configured to distinguish between different chunks of stored data, including by providing information or an indication of where one piece of information stops and the next begins in associated storage media. The file system in some embodiments may separate the data, and/or data addresses, into individual pieces, and then provide each piece a unique identifier, so that the information can be separated and identified. In some embodiments, a specific group of data may be a “file” or an “object”. The structure and logic rules used to manage the groups of information and their names is called a “file system”. There are many different kinds of file systems and each one may have different structure and logic, properties of speed, flexibility, security, size and more. Some file systems have been designed to be used for specific applications. For example, the ISO 9660 file system is designed specifically for optical discs. File systems can be used on many different kinds of storage devices and/or different kind of media. Some file systems are used on local data storage devices, whereas others provide file access via a network protocol (for example, NFS, SMB, or 9P clients). Some file systems are “virtual”, in that the “files” supplied are computed on request (e.g. procfs) or are merely a mapping into a different file system used as a backing store. The file system may manage access to both the content of files and the metadata about those files. The file system may be responsible for arranging storage space, reliability, efficiency, and tuning with regard to the physical storage medium. The file system may be responsible for associating file names with data and data objects (as well as the naming conventions associated therewith), managing and allocating the available storage space and storage namespace in the data object store and/or the data storage resources associated therewith, maintaining file hierarchies (such as directories, folders or indices), associating, storing and/or creating metadata associated with data or data objects, maintaining and carrying out utilities and/or administrative tasks relating to the data object store and/or the data storage resources associated therewith, security and access restriction/authentication of the data object store, and/or maintaining integrity and performance for data in the data object store.

In embodiments, the data object store file system may include commercially available file systems, or other proprietary file systems specifically implemented for distributed data storage systems. Non-distributed file systems (e.g., FAT, UFS, or NTFS) may be used for systems having a single data storage component, or alternatively, with multiple data storage components wherein each of one or more of a given data object store is limited to a single data storage component, or in yet another alternative, with multiple data storage components wherein additional compatibilities are implemented to render the non-distributed file system compatible with distributed storage components, In embodiments, the contents of the proprietary data object store file system is accessed via a storage access protocol, including for example, the NFS protocol. As illustrated by the preceding example, both the data object store file system and the storage access protocol may themselves be file systems, or (in the case of the latter) an access protocol in accordance therewith. As such, embodiments support accessing the contents of the data object store file system by other protocols such as, but not limited to, iSCSI, the NFS protocol, the HDFS protocol, or HTTP-based access protocols such as Amazon S3. The data object store file system, in general, is configured to expose (or render exposable) the data object store by any application-specific data access protocol. This may be accomplished by a specific API exposed by the data storage system for rendering the data object store (or specific functions relating thereto) accessible by the data access protocol; alternatively, the proprietary data object store file system may include interfaceable functionalities which can be accessed by pre-determined data access protocols, or have generalized function interfaces, for exposing the data object store to the data access protocol.

In some embodiments, the distributed data storage system can prioritize or de-prioritize the application-specific processing depending on the priority and/or relative priority of any of the following: the application-specific process, the client data used by the application-specific processing and/or data requests therefor, the client data residing on the same data storage component on which then VPU carrying out data processing and is not used by or otherwise associated with the application-specific processing, the results of the application-specific processing, or any other processes that may be implemented within the data storage system during the application-specific processing. In some embodiments, one or more nodes available for application specific processing coordinate amongst themselves to dedicate processing resources to the one or more VPUs implementing a given application-specific process. Such dedicated processing resources may involve allocating namespace or processing time/priority to nodes having processing characteristics that are associated with the relative priority of the application-specific processing running on such VPU. In some embodiments, the nodes (in some cases in conjunction with the switching component) are configured to ensure that data with higher priority (e.g. “hot” data or data that will soon be “hot”) is promoted to higher tiers of storage and, vice versa, that lower priority data (e.g. “cold” data or data that will soon be “cold”) is demoted to lower tiers of storage. The prioritization/de-prioritization of the application-specific processing is in many ways analogous to the prioritization/de-prioritization of data stored in the data object store. The VPU may be instantiated or migrated to a node having available or excess processing capabilities depending on the relative priority of the application-specific processing to any other processing requirements being carried out on the node(s) on which the VPU is currently running, if applicable, and/or to which the VPU may be instantiated or migrated. In addition, data required by the application-specific process being run on the VPU may be moved to higher or lower tier storage depending on the priority of the application-specific process; the prioritization may be relative to other processes requiring access or use of the same data or same storage tier. In many cases, the results of the application-specific may be associated with lower tier storage or “dark” storage and/or appropriate for varying degrees of compression, but this need not always be the case; in some cases, the results of the process, and the process itself will be associated with a high priority that will cause the data storage system to prioritize processing power of such application-specific process above other application-specific processes, or indeed other storage-related processes. In either case, the applicable VPU can be moved to a processor (or group of processors, in cases where the VPU is instantiated by or across multiple data storage components by, for example, the use of interconnected data storage appliances on each component) having available or greater processing resources or capacity, or available capacity that better aligns with the priority of the application-specific process in question relative to that of the data storage processes or other application-specific processes that may be running on the data storage system. The data associated therewith can be managed in terms of its placement in data storage tiers independently of the priority of the application-specific processing, although in some cases it may be necessary to promote data to higher tiers of storage in order to satisfy the priority of the process. The determination of the priority of the application-specific process, and/or the results of the application-specific process, may be assigned by a client, user, administrator, or other entity, or they may be generated or determined by algorithm or prediction based on past, current or future events by the data storage system.

In some embodiments, an application-specific process may be migrated from one or more of the data storage components, on which the VPU within which the application-specific process is running, to others due to a change in priority of the process, or a change in relative priority with respect to other processes (relating to data storage or application-specific processes or objectives). Such migration may occur by migrating the VPU from a first set of one or more data storage components, to another set of data storage components that have at least one different data storage component. Migration of some or all of the processing of a VPU to other nodes may occur for other reasons as well, however, such as maintenance, equipment failure or malfunction, testing purposes, or any other reason. In embodiments, VPU may be migrated to lower loaded data storage components, in order to, for example, enable application-specific processing or analysis performed inside of a VPU without impacting data storage performance, or otherwise remaining ‘invisible’ to clients of the data storage system. This may be achieved by any of the following non-limiting examples: predicting access patterns of clients and their required storage performance; scheduling analysis for a periods of low client access, possibly on data storage resources that are associated with a lower number of data requests/responses and/or do have other data storage analyses taking place thereon at conflicting time.; prioritizing data being accessed by the VPU, which may demote data that was last accessed by another client, but in respect of which the system can have a level of confidence that it will not be accessed during processing (for example, due to a predicted access pattern analysis); or de-prioritizing data accessed/generated by the VPU after analysis has complete and promote the client data which was demoted earlier so that the client does not perceive any drop in performance the next time the access the data storage system.

As used herein, priority of data generally refers to the relative “hotness” or “coldness” of such data, as these terms would be understood by a person skilled in the art of the instant disclosure. The priority of data may refer herein to the degree to which data will be, or is likely to be, requested, written, or updated at the current or in an upcoming time interval. Likewise, the priority of an application-specific process, or indeed any process being carried out by the data storage system, may refer to the degree to which that process will be, or is likely to be requested, or carried out or in an upcoming time interval. Priority may also refer to the speed which data will be required to be either returned after a read request, or written/updated after a write/update request; in other words, high priority data may be characterized as data that requires minimal response latency after a data request therefor. This may or may not be due to the frequency of related or similar requests or the urgency and/or importance of the associated data. In some cases, a high frequency of data transactions (i.e. read, write, or update) involving the data in a given time period will indicate a higher priority, and conversely a low frequency of data transactions involving such data will indicate a lower priority. Alternatively, it may be used to describe any of the above states or combinations thereof. In some uses herein, as would be understood by a person skilled in the art, priority may be described as temperature or hotness. Priority of a process may also indicate one or more of the following: the likelihood that such a process will be called, requested, or carried out in an upcoming time interval, the forward distance in time until the next time such process will be carried out (predicted or otherwise), the frequency that such process will be carried out, and the urgency and/or importance of such process, or the urgency or the importance of the results of such process. As is often used by a person skilled in the art, hot data is data of high priority and cold data is data of low priority. The use of the term “hot” may be used to describe data that is frequently used, likely to be frequently used, likely to be used soon, or must be returned, written, or updated, as applicable, with high speed; that is, the data has high priority. The term “cold” could be used to describe data that is that is infrequently used, unlikely to be frequently used, unlikely to be used soon, or need not be returned, written, updated, as applicable, with high speed; that is, the data has low priority. Priority may refer to the scheduled, likely, or predicted forward distance, as measured in either time or number of processes (i.e. packets or requests in a communications stack), between the current time and when the data will be called, updated, returned, written or used. In some cases, the data associated with a process can have a priority that is independent of the priority of the process; for example, “hot” data that is called frequently at a given time, may be used by a “cold” process, that is, for example, a process associated with results that are of low urgency to the requesting client. In such cases, for example, the data can be maintained on a higher tier of data, while the processing will take place only when processing resources become available that need not process other activities of higher priority. Of course other examples and combinations of relative data and process priorities can be supported. The priority of data or a process can be determined by assessing past activities and patterns, prediction, or by explicitly assigning such priority by an administrator, user or client.

The nodes may coordinate amongst themselves to prioritize or deprioritize the stored data associated with the application-specific processing by moving the associated stored data to higher or lower performing storage resources (higher or lower tiers of data). In such embodiments, there may be a switching component acting as an interface, which will direct data requests to the plurality of data storage components; such switching component may or may not contribute to the promotion or demotion of stored data (or data that will be stored) in accordance with priority. An API exposed on one or more of the data storage components can be used to determine if data stored on a particular one or more of the nodes, and possibly related data stored on that or other nodes that may include temporally, spatially, or logically related data objects, should be promoted to higher tier storage or demoted to lower tier storage (or possibly replicated and distributed across one or more nodes for performance benefits). In some embodiments, the switching component can participate in the efficient distribution and placement of data across the data storage components; the switching component may provide instructions to move data and/or it may re-map data in the data object store to resources that better meet operational objectives and/or associate data with resources that are appropriate for the priority of that data and/or designate specific data storage component processing resources for instantiating VPUs for carrying out application-specific processing. In other embodiments, the switch and the data storage components cooperate to prioritize or deprioritize data and/or application-layer processes running on the one or more VPUs in accordance with the relative priority of any one or more of the following non-limiting exemplary considerations: data storage operations, the application-specific processing, the client data associated with the data object store, the data associated with the application-specific processing, the client identity or client type, the client data type. In other words, the data storage system can arrange data (by promotion of hotter data to higher performing data storage resources, or demotion of colder data to lower performing data storage resources) and prioritize or deprioritize the application-layer processing (by moving a given VPU to processing resources with sufficient available capacity to at least meet the priority of the process). It accomplishes the latter by transferring the VPU to the most appropriate data storage component(s) within the data storage system given the priority of the application-layer process and/or by moving the data associated therewith to most appropriately performing data storage resource(s) in light of the priority of the process and the competing priorities of other data in the object store and/or client requests and/or and other application-layer processes. In addition, the output or results of the application-specific processing occurring on the VPU can be output for storage and replication to data storage resources that match the priority of such results (e.g. if the results require low-latency access due to a high priority, they can be moved to higher tier storage, or vice versa).

In embodiments, there are provided interfacing processes used by the application-specific processes being run from within the VPU(s) and which may use one or more application-specific data access protocols. In embodiments, an application-specific data storage access protocol is any protocol used by the application-specific process for interfacing with, or accessing the data in the data object store. In embodiments, the application-specific data storage access protocol may include any protocol or method for accessing data in data storage; it may comprise, or include such aspects therewith, file systems or file system protocols, communication protocols, storage access protocols, interfacing protocols, etc. It is possible that some application-specific processes will use an application-specific data access protocol that is the same as, or compatible with, the data object store file system, but the application-specific processes and/or the VPU(s) are not limited to that protocol. In embodiments, application-specific data access protocols may be used by any application-layer process that uses its own proprietary or application-specific data interfacing protocol, application-specific networking interfaces or protocols (e.g. iSCSI), or any application-specific file systems or other file system protocols (e.g., NFS, HDFS), or any other communication or data storage interfacing protocols that may or may not be supported protocols on the data object store, or a combination thereof. In some embodiments, there may be provided additional integration processes that exists, in some cases between the object store file system and the application-specific data access protocols, and in some cases as a supplement to either or both the object store file system and the application-specific data access protocol which can compensate one or both for inconsistencies or incompatibilities therebetween.

The data object store is generally considered to be the set of data or data objects stored, or allocated or intended for storage, within the data storage system; the data object store also refers to the actual physical storage resources, the virtual storage resources, the addressable storage space, the address space (e.g. mapping or representation) of any of the foregoing, a combination of the foregoing, or any portion thereof. In general, the data storage system implements one or more file systems, which may be NFS or another file system, to manage the data in the data object store in accordance with that one or more file system. Management of data in the data object store may include but is not limited to allocating address space and storage resources, and handling replication, failure, prioritization, updating client data, and handling client requests and client request responses, etc. In some embodiments, the data object store file system may also implement data storage processes for data stored in the data object store.

In many cases, the application-specific data access protocols may include file systems and/or operational, interfacing and/or access requirements that are incompatible with the data object store file system. For example, if in one embodiment the data object store file system is NFS, and a VPU is instantiated thereon for implementing a Hadoop-specific data analysis, embodiments herein address the interfacing of the VPU to the data object store; the VPU uses HDFS to access data in the data object store that is managed in accordance with NFS, and in general HDFS may be incompatible with NFS for some purposes. For example, HDFS is a read only file system protocol and therefore presents incompatibilities when a Hadoop data analysis is taking place on live, and possibly changing, data that may be changed by an NFS supported protocol after the analysis has started—many such changes cannot be therefore be recognized by HDFS without the integration methodologies discussed herein.

As an illustrative example only, if there are changes in the object store after or while a VPU running on the same data object store has initiated an application-specific process that causes an application-specific data access protocol to become at least partially inconsistent with the data object store file system (because, for example like HDFS, it cannot recognize a change to data once accessed), there are provided herein methods, devices, and systems that render the data consistent, even if the utilization of such protocols are concurrent in time.

In one embodiment, the distributed storage system implements a snapshot to render the supported protocols compatible. The snapshot is a portion or a mapping of a portion of the object store that will be used by the VPU-implemented application-specific process. If the data associated with the snapshot is modified while the VPU is processing the snapshotted data, and such change would render the application-specific process invalid or incorrect, or making changes to the data associated with the application-specific process is not possible, a new mapping may be generated in parallel to be used by data clients for access using the data object store file system while the snapshotted data or mapping thereto remains consistent for the application-specific process; when the application-specific process has finished with the snapshotted data, the snapshot may be deleted or dropped, or the mappings for the snapshot may be updated so that the mapping of the snapshot are either mapped to the corresponding live data (which may have been changed during the analysis) or vice versa. In other embodiments, a specific copy is generated within the data object store that is designated for a given VPU process, which is then released once the application-specific process has finished (at which time it may be overwritten or simply allocated as free storage space). In other cases, data sets in the object store are identified as a data set that will not change, or will not be permitted to change, during the VPU-implemented process. In some embodiments, the data may be fenced off within storage (for example, within a given node or nodes, either virtualized or physical). A combination of these may be used as well; for example, if a VPU is instantiated to process data that is not expected to change, it may snapshot in real-time only that data that is used by VPU-processing which is being changed or updated by data clients, the mapping of the snapshotted data and the live data being reconciled after the VPU process has finished.

In some cases, the VPU-implemented protocol may not be incompatible with the supported protocol implemented in the data storage system and/or the data object store. In such cases, the protocols may in some embodiments need to nevertheless be capable of concurrent operation, meaning that changes to the data object store by the data object store file system protocol should be rendered compatible or capable of concurrent data usage/access for use by the application-specific processes and the applicable data access protocols; in other words, client data changes or access to the client data via the data object store file system (e.g. NFS) should not adversely impact or otherwise impact another access protocol (e.g. iSCSI) implemented by an application-specific process running on a VPU, or the results of such process (which may for example re-process any portion or aspect of the application-specific process which has previously been carried out on data from the data object store that has since been changed or updated by a data storage process). Conversely, safeguards must be implemented to ensure that use of the data by the application-specific are visible to, and do not adversely impact (beyond permissible operational requirements) the object store data in a way that improperly changes or affects data storage or any data storage processes.

In some embodiment, there is provided an integration module. In embodiments, the integration module comprises a processor, having access to memory with instructions stored thereon, which is exposed to client data requests and/or responses (i.e. to be handled directly by the data object store file system) as well as data requests and/or responses originating from and/or sent to application-specific processes running within a VPU (e.g. Hadoop data accesses in accordance with HDFS). Said integration module may be configured to implement the necessary implement changes and/or supplemental requests or other actions to do any of the following, inter alio: update the application-specific process data access protocol (including an application-specific file system, which may form part of the access protocol), update the data object store file system upon changes by an application-specific process and/or via an application-specific data storage access protocol, expose the data object store file system to changes implemented by the application-specific process, to create snapshots of data specifically designated for application-specific processes, maintain separation between data relating to application-specific processing that is not compatible with independent changes by other data clients, reconciling snapshots and live data after or during processing, implementing safeguards against conflicts arising due to use of the same data which is related to both data client and application-specific processes, generally rendering compatible the application-specific processing and data access protocols with the data object store and data object store file system, and combinations thereof. It may comprise of a discrete computing device (including a VM) located within the data storage system, or it may be an API or other programming running on any one of the processors associated with the data storage components and/or the switching component. In some embodiments, the application-layer processes implemented by the integration module may be run as or from within a VPU specifically instantiated to run such processes; in some cases, the application-layer processes implemented by the integration module may be implemented by the same VPU(s) instantiated for a given application-specific process, which may or not be related to the application-specific process relating to the integration services provided by that integration module. In some embodiments, the integration module consists of a computing device having a memory and a processor that exposes an API for performing integration services in respect of any one or more application-specific process and/or the VPU associated therewith; and/or it may comprise a set of instructions stored on an accessible data storage resource which, when carried out by the integration module processor, causes the integration services to be run by the integration module and/or any communicatively coupled processor.

In some embodiments, the direct access to the data storage system and the data object store permits efficient access to a commonly used data storage system. For example, there is common access, common layout, etc. across access a number of different protocols (including both the data object store file system and one or more application-specific data access protocols associated with possibly a wide variety of application-specific processes). As such, in some embodiments it may not be necessary to generate multiple data storage systems and/or data object stores, and then reconcile such multiple systems and/or object stores when independent processes are carried out that impact the same data. In some embodiments, hooks to storage by Hadoop are thus improved and may, for example, reduce many of the underlying inefficiencies associated with Hadoop since data location management need not be carried out by Hadoop; this is already an underlying process of some embodiment of the data storage system and so combining Hadoop on top of the live data store avoids requiring non-data processing activities (e.g. which may be required to move data to closer racks).

In some embodiments, Hadoop/analytics processes and tools can be implemented for any reason or any data analysis client, including to provide useful data services processes as application-specific processes for the data storage system itself, related data storage processes, and data clients. Such data services may be implemented as application-specific processes that improve, supplement, or provided administrative functions for the data object and data-related processes. Such data services may include the following non-limiting examples: deduplication, compression, audit, e-discovery, garbage collection, and data storage capacity analyses (e.g. calculation, trending and reaction on specific data and/or storage locations and media and/or for specific events). For example, Hadoop may permit useful data analysis tools that may improve or provide informational insights into data storage processes, such as analysing specific data sets within the data object store to understand access frequency and changes in data priority of such data sets or portions thereof, as well as how these characteristics may change over time. In addition, certain administrative services may be implemented in more efficient ways by such data analysis services and/or other application-specific processes being run from with a VPU, possibly in response to the aforementioned data analysis of the data object store. As one example, the application-specific process may assess access frequency with specific sets of data and then implement varying levels of compression for sets of data associated with a specific ranges of access frequency, wherein the data associated with the lower levels of access frequency (or other indication of priority) are stored with the higher level of compression and vice versa. In general, with higher compression, there are significant benefits gained in storage efficiency but latency and throughput performance become lower. Using an application-specific process for auditing usage of a data storage and/or specific data therein by specific users or classes of users may be more efficient than using the data object store file system. Similarly, searching large scale sets of data, with structures completely unrelated to the needs of the data search, may be better performed by specific applications, such as but not limited to Hadoop, when carrying out e-discovery activities, or other types of searches. In such examples, identifying data relating to a specific matter, data, activity, person, event, time period, keyword, or combination thereof, for example, as well as other criteria that may be used for e-discovery activities, can be provided by storage-side processing by implementing the process on available data storage side processing. Administrative services, such as garbage collection, namespace analysis and re-arrangement, and deduplication, may also be implemented by application-specific processing configured or configurable specifically for these activities, and then by permitting the data storage system to permit these analysis and the administrative processes to be implemented by VPU on non- or under-utilized processing resources when such processors are not required for responding to data client requests.

Another data service example may include the selection of data for, and the carrying out of, backup and/or archival functions. For example, the application-specific process may work through the data in the data object store to identify all file snapshots older than a predetermined time period (e.g. >3 weeks), and then send them to an archival storage layer (such as magnetic tape or Amazon's Glacier storage service), then delete the data from the data object within the data object store. In embodiments, such data services processes may be implemented to extend the functionality of the underlying data storage system. Such data services, including data services analytics, can be driven by events in the distributed storage system that are exposed by an API. The data services may include Data Driven Analytics; that is, application-specific processing based on, triggered by, or analyzing of events in the data object store that are implemented by or detected by the VPUs by the data storage system. Such data driven analytics may trigger the start of a data analysis inside of a VPU based on one or more events, including but not limited to: identifying, assessing and altering data storage system state (e.g. data promotion/demotion, garbage collection, compression, deletion, priority assessment, among others), Data Access (e.g. implementing a data service upon file create/read/write), assessment of data contents by pattern (e.g. Social Security Number, IP address, email address, postal code, or other type of data). Data services may be used to expose data locality: upon which node(s) replicas of the data are stored, so that, for example, analysis can be scheduled close to the data or related data can be collocated and/or moved to an appropriate storage tier. In other embodiments, services and analysis running inside of VPUs may be implemented to support programmability of data services. A data service extends the base functionality of the data storage system. Examples of Data Services that could be programmed as analyses and run inside of VPUs include: Deduplication (scanning the data object store for identical file contents); Compression of file contents by access time (for example, do not compress data that is accessed frequently, compress data that is accessed infrequently with a computationally cheap and fast compression algorithm with ratio of 2:1, compress data that is never accessed with a computationally expensive and slower compression algorithm with a ratio of 8:1—other embodiments wherein degree of compression is inversely proportional to access frequency or priority can be implemented). In some embodiments, these application-specific analyses may be combined or chained; for example, the results of one analysis may be used as input into, or a trigger for, another process. For example, an e-discovery search may be implemented across one or more Hadoop-implementing VPUs, the output of which could be served up by one or more web server VPUs for consumption by end-users with a web browser.

Conventional Hadoop workflow processes may be implemented in accordance with the following steps: (1) The Hadoop compute stack (sometimes referred to as JobTracker) asks NameNode “tell me where /file/path lives;” (2) NameNode returns DataNode addresses for each of the blocks being accessed for analysis/processing corresponding to the data making up the requested data; (3) JobTracker assigns specific computation processes to read each block using the list of DataNodes returned to align compute with where the data is stored; (4) Tasks launched by each specific computation process ask NameNode for block locations, then initiate I/O to read the data over the network from the DataNodes. This process is modified on embodiments, often by processes implemented by the integration module, by exploiting step (3) to control where and/or when a compute job gets scheduled. For example, the address of a data storage location in a data storage component may be returned to the HDFS by the integration NameNode in step (2), wherein the address is associated with the data storage component having a replicate of the data which has more available processing resources than another data storage component that also has a copy of the replicate, as determined by the appropriate priority relative to other demands on the processing resources. Similarly, embodiments of the data storage system may utilize NameNode task to load-balance Hadoop computation efficiently across the cluster of data storage components by round-robining through all nodes and/or storage tiers, in the cluster when handing back addresses in step (2) in order to best meet process priority requirements taking into account processing time, quantity of data associated with data storage, and available processing resources. Alternatively, information relating to load-balancing by the switching component may be used to return addresses of the nodes that are least loaded to the HDFS and/or Hadoop compute stack. In embodiments, there may be pre-fetching of data for files that are associated with a Hadoop job that is going to be run or is running onto the node that is going to run the job, before the job accesses it. This type of functionality is not possible with conventional HDFS implementations because data for file chunks has static locations (a chunk is only present on 3 DataNodes). Embodiments of the instant data object store file system allows for dynamic movement/placement and/or snapshotting of data across nodes the cluster. The above examples of dynamic data movement/placement within the data storage system, including load balancing techniques, may be applicable to any application-specific processing, and thus they can be used for other examples of embodiments described herein.

### Example System: Hadoop Data Analysis as Application-Specific Process in Container as VPU

In embodiments, the application-layer processes relate to data analytics; in this example, the data analytics application-layer process is a Hadoop-based application, and the VPU that is instantiated on one or more storage system node processors is a docker container. Other embodiments may use different VPUs for running the application-specific process (e.g. a VM, a jail, or some virtualized OS or processor). By having the container implemented on the storage system, the data analytics processes can (1) leverage the storage-system's inherent functionality to utilize processing resources available across some or all of the storage nodes when other processing resources currently may be under-utilized or associated with lower priority processes (whether they be data storage related processes, such as processing data requests, including reads or writes or other storage-related activities, or other application-layer or other processes running on alternative containers); (2) carry out data analysis directly on live data, ensuring currency of data and increased efficiency since additional copies specifically for the data analysis processing are not required; (3) to move data being utilized for Hadoop data analysis to the most appropriate data storage resources, while, in some embodiments, continuing to provide all data storage requirements for data clients (e.g. performance matching for data analysis requirements, particularly in relation to competing data storage performance requirements for shared data or data storage resources); and (4) to “fence off” data and snapshots thereof during data analysis. Other functionalities are also made possible by integrating application-layer processing with data storage. Conversely, Hadoop has a number of programming capabilities that may permit the implementation of analysis of the data object store that can be used to assess characteristics thereof to improve storage performance (e.g. data services). For example, Hadoop data analysis can be used to analyze data sets in, or comprising a portion of, the data object store to assess various data-storage related information, including by not limited to, access frequency, co-relationships of data objects (because for example they are requested at the same or related times by the same or similar clients and/or users), audit functions (for example, determining who accessed certain data and when it was accessed), e-discovery (for example, data objects that may have some relationship with a certain subject matter, client, keyword, access time or frequency, and/or user), garbage collection, namespace analysis, and compression analysis. Although conventional Hadoop applications may not implement any changes to the data object store (since HDFS is generally not able to write data, and is a read-only access protocol), the Hadoop analyses of the data may be the most efficient manner to acquire this information through analysis for then implementing such changes by the data object store file system, or indeed another application-specific process.

In this exemplary embodiment, Hadoop utilizes its own specific application-specific data access protocol, which comprises a Hadoop-specific file system: HDFS. The HDFS interface allows for read and append access to files; but it does not support random writes, which means that a write implemented by the data object store file system (or indeed another application-specific process and/or data access protocol) needs to be integrated into or made compatible with HDFS. HDFS in general does not allow random writes in order to simplify the HDFS implementation and make data access of large data sets faster. In prior art implementations, if a file was updated in-place, all of the blocks that were changed would need to be updated on all three replicas in the cluster, synchronously; in instant embodiments, the integration module may be configured, by having APIs exposed thereon, to update all the clusters efficiently, thus permitting writes to the data storage object (by the Hadoop process, if possible, or via other processes) without impacting performance. Furthermore, HDFS also protects against changes to the blocks that it hosts by storing the checksum of each block alongside the block in a checksum file. In embodiments, in-place updates are allowed, and checksums for each block changed may be re-computed, in embodiments by the integration module, to ensure that verifying all checksums for all block replicas in the cluster would not result in an error (i.e. checksum mismatches are reconciled to ensure they are not a result of error rather than data object store changes independent of HDFS). The integration module may be configured to manage the checksum re-computation, verification and reconciliation, but in some embodiments it may avoid this problem by using a snapshot of the data being analyzed (and replicas thereof), fencing off data (and replicas thereof), or by correcting or reconciling the checksum (which can be done without impacting performance beyond permissible limits due to the association of the data and the VPU with appropriately performing data storage tiers and processing resources).

Hadoop users are generally forced to work around changes any changes in the base data. For example, in a prior art Hadoop Cluster, if a file in the base data set is changed, a new copy of the file would need to be ingested into HDFS, and either: 1) Delete the old file with stale data (e.g. ‘delete foo’) and copy in the new file—in its entirety—with the updated data. 2) Or, copy in the new file with a new name (e.g. ‘foo.updated_2014Nov05’) and update analysis code in Hadoop to reference the new file instead of the old one. In case 1) there is a significant lag between when file in the base data set is changed and when the updated data is available to be used in Hadoop analysis. In case 2) there is a need to update the analysis code to reference the updated data, and the original data is never deleted, which wastes storage space.

In embodiments, the integration module will host, or facilitate the hosting by the data storage system, an integration implementation of the HDFS protocol on the nodes which is run alongside NFS. In some embodiments, this may include effectively running an integration implementation of the NameNode and DataNode Hadoop services separately from the Hadoop compute stack (either inside the same or a different VPU, in the integration module, or on one or more of the nodes), while the Hadoop compute stack is maintained inside of the VPU and run unmodified while directing the compute at the integration-module implemented NameNode service. In embodiments, the data storage system may be configured to control/influence where Hadoop compute jobs run in the data object store cluster, in order to increase and possibly optimize utilization of storage-side processing resources, while maintaining the storage-related benefits of the data storage system. This protocol integration is contrasted with the existing Hadoop NFS Gateway. In short, the Hadoop NFS Gateway does not provide general purpose NFS access to data, since in the Hadoop NFS Gateway it is, in contrast to at least some embodiments described herein, an NFS shim on top of HDFS, it is bound to the access limitations of the underlying HDFS protocol; namely, random writes are not supported, and NFS requests may be sent out-of-order by clients. As such, write requests must be buffered by the Hadoop NFS Gateway until a contiguous range of writes can be translated into an ordered set of appends on the underlying HDFS file system (see e.g.: https://hadoop.apache.org/docs/r2.3.0/hadoop-project-dist/hadoop-hdfs/HdfsNfsGateway.html). In contrast, embodiments hereof may avoid this limitation in order to ensure direct access to the data object store, without impacting data storage processes. This may be accomplished by exposing the application-specific data access protocol as a direct interface to the data storage system; and translating from application-specific data access protocol requests to requests in the underlying data object store file system while rectifying incompatibilities between the application-specific data access protocol and the underlying data object store file system.

As an example of the above, embodiments of the instant data storage system exposes both NFS and HDFS access to the same underlying objects in the data object store. This is in contrast to the Hadoop NFS Gateway, which is a software layer that translates NFS protocol requests to HDFS protocol requests, with the underlying file system being HDFS with all of its limitations. The Hadoop NFS Gateway only exposes a subset of NFS functionality; it omits functionality that is not supported by the underlying HDFS file system; for example, it is read and append-only so random writes are not supported in the Hadoop NFS Gateway.

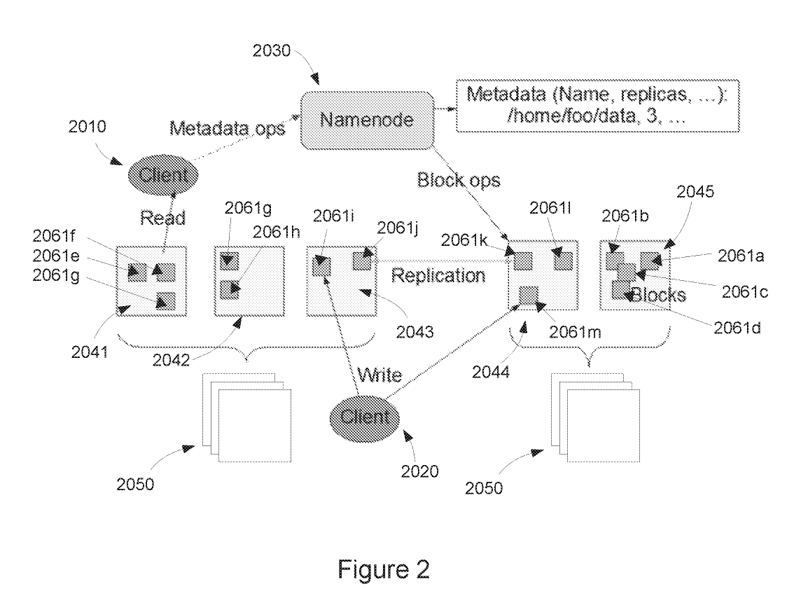

With reference to FIG. 2, a conventional Hadoop architecture and processes are shown for illustrative purposes. While the Hadoop Distributed File System (HDFS) is a distributed file system designed to run on commodity hardware, it has many similarities with existing distributed file systems, such as NFS. There are, however, differences from such distributed file systems which may, in some cases, be significant (as such, the VPUs described herein may implement a file system integration functionality which permits the HDFS, or indeed any application- or context-specific file system (including NFS), to recognize changes in the underlying data storage system file system, and, if necessary, reconcile any past or ongoing processing using the data that has been changed). In general, HDFS may be considered to be highly fault-tolerant and designed to be deployed on a wide variety of hardware. HDFS provides high throughput access to application data in a data object store and is suitable for applications that have large data sets. HDFS relaxes a few POSIX requirements to enable streaming access to file system data, which is permitted as implemented in the VPU. In addition, HDFS has reduced functionality for any processes not specifically required for data analysis. For example, HDFS has read-only, read and append only, random read, and sequential write (at end of a file—random writes are not supported) capabilities with respect to the object store. In embodiments, the file system integration functionality of embodiments disclosed herein may, for example, generate a snapshot of a portion of the data object store for the HDFS, segregate or otherwise designate specific data that is unlikely to be change (or will not be permitted to change), or cause the HDFS to update itself with the associated data in the object store by updating the NameNode run by the data storage system and reconciling any changes to data (as opposed to that typically run by conventional Hadoop implementations).

As shown in FIG. 2, standard HDFS has a master/slave architecture with implemented by a namenode 2030 and one or more datanodes 2041 to 2045 and accessible and/or implementable by one or more clients 2010, 2020. Contrary to an HDFS cluster in embodiments of the instant disclosure, which may consist of a NameNode running on a Hadoop-configured docker instantiated by the one or more processors of the data storage resources, the conventional Hadoop architecture requires that the data (or the data object store) be transferred for analysis to a separate storage system, generally comprising of one or more racks of storage media 2050, 2051. The NameNode 2030 is configured to operate as a single master server that manages the HDFS namespace. One or more DataNodes 2041 to 2045 manage storage attached to the nodes that they run on. HDFS exposes a file system namespace and allows user data stored in the DataNodes 2041 to 2045 to be accessed as HDFS files. The NameNode 2030 executes file system namespace operations like opening, closing, and renaming HDFS files and directories. It also determines the mapping of blocks to DataNodes DataNodes 2041 to 2045. The DataNodes 2041 to 2045 are responsible for serving read and write requests from the file system's clients 2010, 2020. The DataNodes 2041 to 2045 also perform block 2061A to 2061M creation, deletion, and replication upon instruction from the NameNode 2030.

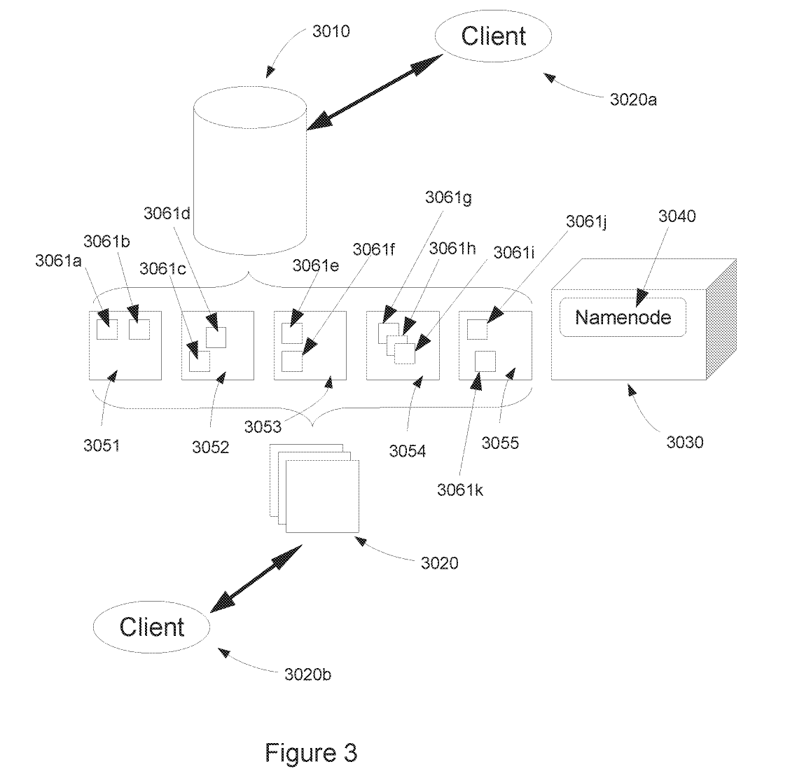

In contrast, with reference to FIG. 3, embodiments herein permit data in the data object store 3020 of the data storage system to be modified underneath HDFS in the data object store, which comprises live data and/or data being used by other processes and data clients. In embodiments, implementation of the HDFS protocol in the VPU 3010, in accordance with a request for data analysis by a data analysis client 3020a, permits direct communication with the data object store 3020 and with data (e.g. block, data objects) 3061A to 3061K. The data blocks 3061A to 3061K correspond to blocks of data that are addressable and/or used by the data object store file system, and the NameNode 3040 implemented by the integration module 3030 permits the HDFS to view and interact with such blocks the same way HDFS in a conventional system would interact with blocks of data in datanodes. In this case, the DataNodes 3051 to 3055 are implemented using software to associate them to related the data blocks 3061A to 3061K, where such association may be due to their existing relationship due to being associated with the same node; as such, HDFS and the integration-implemented NameNode 3040 can view these blocks and DataNodes 3051 to 3055 in the same way that HDFS on a conventional Hadoop implementation would view them. In some cases, the DataNodes 3051 to 3055 in instant embodiments may be or may be directly associated with nodes (i.e. data storage components and/or resources thereof), but in other cases the integration module 3030 may, for example through emulation, address mapping or namespace management, virtualize the DataNodes 3051 to 3055 so that the Hadoop compute stack views and interacts with them even though the data blocks associated therewith may in fact be located on different nodes in the data storage system. Indeed, the data storage system may choose to assign any one of a plurality of different but corresponding data blocks (e.g. a replicate that is stored on higher tier storage, or is fenced off, or is snapshotted) to an emulated DataNode, and this assignment may change during the Hadoop process as priorities in the data storage system change. Changes to the data object store file system namespace (file creation and deletion) via other storage access protocols (including both by data clients 3020b via the data object store file system as well as other application-specific processes) are made instantly visible via the HDFS NameNode 3040 protocol implemented in FIG. 3 in the integration module 3030 (although it can be run alongside the Hadoop compute stack within the same VPU(s) 3010 or it can be run on other VPUs (not shown) or elsewhere on available data storage components). Files in the data object store file system that are visible via HDFS may be modified via other storage access protocols such as NFS. The data object store maintains synchronization of all file replicas as well as the integrity of each file by performing checksums internally. Modifications that are made to a file that is being used by a Hadoop analysis may be hidden until the analysis completes by using features of the data object store file system when implementing integration mechanisms such as snapshots; for example, if an analysis is going to use a file, take a snapshot of a file, run the analysis against the snapshot, and delete the snapshot when the analysis completes, or update the snapshot by reconciling it with changes implemented to the data (by, for example, copying the live data to the snapshot and releasing the changed data and/or mappings to the snapshotted data as the live data).

In embodiments, the integration NameNode and DataNode are pieces of software designed to run on commodity machines; in embodiments, the integration NameNode may run within an instantiated VPU or alternatively the integration module, and the integration DataNode provides functionality that permits data storage components (or nodes) to operate, or appear from the perspective of the Hadoop compute stack in the VPU, as a conventional Hadoop DataNode. Such integration Data Nodes may be emulated within the data storage system by functionality associated with the integration module, the data storage components themselves, or the VPU running the Hadoop process. Such functionality may be enabled by one or more APIs or other sets of instructions stored within the data storage system. In embodiments, multiple integration DataNodes can be run on the same node. The integration NameNode may be the arbitrator and repository for HDFS metadata.

In general, HDFS supports a traditional hierarchical file organization, and such file organization can be implemented within the applicable VPU. A user or an application can create directories and store files inside these directories. The file system namespace hierarchy is similar to other existing file systems; one can create and remove files, move a file from one directory to another, or rename a file. The NameNode maintains the file system namespace. Any change to the file system namespace or its properties is recorded by the NameNode, and as such, any change made under the feet of HDFS via the data object store file system must either be updated to the NameNode or the data must be later reconciled (e.g. snapshotted or fenced data and live data must be reconciled with the corresponding current data). An application can specify the number of replicas of a file that should be maintained by HDFS, although in general, this may be entirely left to the data storage system which undertakes such functionality for system-wide performance and failsafe reasons in any event (while still maintaining scalable and customized performance for all clients and/or all purposes). The number of copies of a file is called the replication factor of that file. This information is may be stored by the NameNode, or it may be acquired by the NameNode from the data storage system (e.g. from the data object store or the data object store file system).

In embodiments, there are specific APIs (or other modules or interfaces for implementing instructions on a processor) for interfacing the data storage system file system with HDFS. In this exemplary embodiment, the data storage system either instantiates a docker or assigns a previously instantiated docker for data analysis. The docker is configured to permit data associated with the data storage system file system, which in some embodiments may utilize NFS (although any other file system may be used), to be addressable by the Hadoop NameNode (which may be implemented in the same or another VPU or the integration module) via HDFS. Conventional HDFS supports read and append only, and when an analysis process is executed, HDFS may use all chunks of the data that are available at the time job started and the chunks will generally not change while the analysis runs. Data in stored in embodiments of the instant data storage systems can be read or written with random access, even during the analysis process, so in some embodiments the integration module may be configured to, inter alio, (i) generate and execute analysis processes against snapshots of the data being analysed, (ii) permit the chunks of the data used in the analysis (and assigned replicas thereof) to become less current than other replicas stored in the data storage system, such other replicas being assigned for data storage processes (which may be dropped or reconciled at a later time, including any checksum corrections, possibly before or after the analysis is finished); or (iii) make copies of the data for within the data storage system that is dedicated for the data analysis processes (which may be deleted or released after such analysis has finished). In some embodiments, the selection of which of these options that is in fact implemented, if required, may be associated with the priority of the data analysis process and, in some embodiments, such priority may be determined in advance and/or during analysis by an administrator or client or through predictive analysis by the data storage system.

In historical systems, hardware failure has been the norm rather than the exception. An HDFS instance may consist of hundreds or thousands of server machines (or in this exemplary embodiment, hundreds or thousands of data storage system nodes), each storing part of the HDFS data. The fact that there are a huge number of components and that each component has a non-trivial probability of failure means that some component of HDFS may be non-functional at any given time. Therefore, detection of faults and quick, automatic recovery from them is a core architectural goal of conventional Hadoop implementations, and thus as part of HDFS. Since the data storage system already has such fault detection and recovery associated with the live data, some of which may be under analysis at any given time, additional copies of the data specifically for data analysis processes being run within the data storage system are not required specifically for this reason as it relates to HDFS. Indeed, much of the functionality associated with Hadoop applications and HDFS are already implemented and carried out by the data storage system for reasons that relate generally to improved data storage system performance. For example, Hadoop in conventional systems is concerned with moving data associated with a given analysis to co-located storage resources (e.g. the same “racks”), while ensuring that data replicates are available when some data resources become unavailable; since the data storage system is already performing these functions, and particularly in respect of a wider variety of storage tiers, HDFS need not also perform these functionalities, even though it is configured to do so.

In general, applications that run on HDFS need streaming access to their data sets. HDFS is generally intended for more batch processing rather than interactive use by users, and there is an emphasis is on high throughput of data access rather than low latency of data access. POSIX semantics in a few key areas may be traded to increase data throughput rates in conventional HDFS implementations, since POSIX imposes many hard requirements that are not needed for applications that are targeted for HDFS. Because, however, NFS and HDFS interface at live data in embodiments of the data storage system means streaming access to live data becomes possible and such high throughput for live data, particularly due to the co-location of data analysis processing and data storage, becomes augmented. Since the data storage system provides functionality similar to this for other reasons, including increased performance and reliability of stored client data, HDFS can leverage this pre-existing functionality.

In general, applications that run on HDFS have large data sets. A typical file in HDFS is gigabytes to terabytes in size. Thus, HDFS is tuned to support large files and/or large number of files. It should provide high aggregate data bandwidth and scale to hundreds of nodes in a single cluster. It is configured to support tens of millions of files in a single instance. Embodiments of the data storage system is configured for scalable support for such files and to promote (or demote, as the case may be) the data associated with the data files to storage tiers that will facilitate the necessary data bandwidth (including when “necessary” relates to the priority associated with the data and the application-specific data processing).

In general, HDFS applications use a simple coherency model, meaning that they only need write-once-read-many access model for files. A file once created, written, and closed need not be changed. This assumption simplifies data coherency issues and enables high throughput data access. As such, by placing the Hadoop compute stack directly on top of live data in a VPU, some integration steps may be required if files get updated through other means; such steps may include snapshotting, fencing, pre-identifying data with a low or reduced likelihood of being changed during analysis, and running Hadoop analyses during time periods associated with a low likelihood of change for a data set associated with the analyses.

One of the motivating tenets of conventional Hadoop analysis is that moving computation is cheaper than moving data. This tenet is embodied in Hadoop by implementing data storage within a conventional Hadoop analysis data storage system (to which data for analysis is specifically copied therefor) such that data and replicates thereof are stored “near” the computational analysis being performed by a given Hadoop application; this typically means data required for analysis is stored on the same or directly connected racks of storage resources. In general, a computation requested by an application is much more efficient if it is executed near the data it operates on. This is especially true when the size of the data set is huge. This minimizes network congestion and increases the overall throughput of the system. The assumption is that it is often better to migrate the computation closer to where the data is located rather than moving the data to where the application is running. HDFS provides interfaces for applications to move themselves closer to where the data is located. When implemented on embodiments of the instantly disclosed data storage system, the system is already configured, independently of the application-specific processes, such as Hadoop, to move data “nearer” and onto appropriately-performing storage tiers that will facilitate a given Hadoop compute stack. This includes moving the VPU “closer” to the associated data in the data object store, moving the data (or a more heavily used portion of it) to higher tier storage or storage that is nearer the VPU, or a combination thereof.

Conventional HDFS is designed to reliably store very large files across machines in a large cluster. Convention HDFS stores each file as a sequence of blocks; all blocks in a file except the last block are the same size, and such blocks of a file are replicated for fault tolerance and the number of replicas of a file can be specified. In embodiments of the instant data storage system, the integration NameNode can make decisions regarding replication of blocks, it can rely on the replication of the blocks already being implemented by the data storage system, or it can, via an API exposed within the data storage system, request an increased or decreased replication factor for the associated data blocks (which the data storage system may fence off or create a snapshot of some replicates for use by the Hadoop compute stack and expose those to HDFS). The integration NameNode and integration DataNode software applications can periodically create a Heartbeat and a Blockreport from each of the DataNodes in the cluster. Receipt of a Heartbeat implies that the DataNode is functioning properly. A Blockreport contains a list of all blocks on a given DataNode associated with the NameNode.

Much of conventional Hadoop implementation relies on careful replica placement policy. The placement of replicas is critical to conventional HDFS reliability and performance in conventional systems, and optimizing replica placement distinguishes HDFS from other distributed file systems, and is in prior systems a feature that needs lots of tuning and experience. Conventional Hadoop implementation requires a rack-aware replica placement policy to improve data reliability, availability, and network bandwidth utilization. By implementing Hadoop within a VPU running directly on a data storage system that optimizes data storage in accordance with the underlying requirements for that data (i.e. hot data on higher tier storage), the data storage system avoids the need for such tuning by an application-specific process running on a VPU therein—the data storage system already takes care of this. Instead of running large HDFS instances run on a cluster of computers that is commonly spread across many racks, the data storage system arranges the data on the most appropriate storage tier, wherein the type of resource (e.g. flash or spinning disk) as well as the “closeness” is a consideration in such storage requirements. Communication between two nodes in different racks in conventional distributed storage systems implementing Hadoop computation has to go through switches, wherein network bandwidth between machines in the same rack is greater than network bandwidth between machines in different racks, embodiments of the instantly disclosed data storage system do not suffer from this performance limitation. In embodiments, the data storage system has already moved data, and/or its replicates, to the most appropriate storage tier to match performance requirements of the data and the analysis. The integration NameNode need not determine the rack id of each DataNode, as would be required in conventional Hadoop implementations, but it may communicate a failure to achieve required performance to the data storage system wherein the data storage system may implement a revised data storage arrangement by moving the data to different storage resources that more closely match the performance requirements (failures may also be communicated, but the data storage system in many embodiments are configured to resolve such failures independently of the application-specific process and these may, in such cases, be resolved as part of the operation of the data storage system).

Much of Hadoop operation in a conventional implementation is concerned with rack location policy. For example, when the replication factor is three, HDFS's placement policy is to put one replica on one node in the local rack, another on a node in a different (remote) rack, and the last on a different node in the same remote rack. This policy cuts the inter-rack write traffic which generally improves write performance. The chance of rack failure is far less than that of node failure; this policy does not impact data reliability and availability guarantees. However, it does reduce the aggregate network bandwidth used when reading data since a block is placed in only two unique racks rather than three. With this policy, the replicas of a file do not evenly distribute across the racks. In embodiments of the instant disclosure, the data storage components are closely coupled communicatively, but are operationally independent; that is, they are configured for very high speed communication with one another and include multiple tiers of data storage. As such, the operational limitations and concerns relating to rack placement in a standard Hadoop implementation simply do not apply: the data storage system manages data placement to closely match required storage performance, and replication policy as a failsafe mechanism need not cost performance in the same was as conventional data storage systems using Hadoop. Whereas in conventional Hadoop implementations, in which HDFS tries to satisfy a read request from a replica that is closest to the reader to minimize global bandwidth consumption and read latency, the integration NameNode simply satisfies the request from any replica that is on a storage tier that matches the performance requirement and, if there is not one, moves one or more replicas to such storage tier.

In embodiments of the instant disclosure, the HDFS operates in analogous ways to conventional HDFS implementations. For example, in embodiments the HDFS namespace is stored by the integration-implemented NameNode. The integration-implemented NameNode uses a transaction log called the EditLog to persistently record every change that occurs to file system metadata. For example, creating a new file in HDFS causes the NameNode to insert a record into the EditLog indicating this. Similarly, changing the replication factor of a file (which can be implemented by the data object store file system independently of an application-specific process, whether or not changed at the application-specific process) causes a new record to be inserted into the EditLog stored in the integration NameNode's local file system. The entire HDFS namespace, including the mapping of blocks to files and file system properties (which are in some embodiments the same as, or determined from, those mappings as found in the data object store file system—at least at the beginning of a data analysis), may be stored in a file in the integration NameNode's local system as well. The integration NameNode may keep an image of the entire file system namespace and file Blockmap in memory, or it may access or determine this information from corresponding information available from the data object store file system. In some embodiments, this information may be stored locally, as this key metadata item is designed to be compact, such that an integration NameNode with 4 GB of RAM is generally more than sufficient to support a large number of files and directories; in other cases, given that size of the key metadata it can be determined dynamically or periodically or otherwise from the data object store file system. When the integration NameNode starts up, it reads the FsImage and EditLog from storage, from the equivalent information stored in accordance with the data object store file system, or it may generate the files from the data object store file system, and then applies all the transactions from the EditLog to the in-memory representation of the FsImage, and flushes out this new version into a new FsImage in storage. When changes are implemented to those data blocks by processes other than the Hadoop application running on the VPU (e.g. by a data client or another application-specific process), the integration module may be configured to update FsImage and EditLog. When the new FsImage has been flushed out, the integration module can truncate the old EditLog because its transactions have been applied to the persistent FsImage. This process is called a checkpoint. In some implementations of the integration NameNode, the file system metadata and data is stored directly to the data object store file system so that it can be accessed immediately by other protocols. All writes to the data object store file system are replicated before they are acknowledged, so in some embodiments the FsImage and EditLog+checkpointing, that is done to deal with consistency under failure in conventional Hadoop, is not required. In embodiments wherein the NameNode is running inside of a VPU, a similar approach may be implemented.

In embodiments, a DataNode can be a data storage component, or it can be an emulation or virtualization of such a data storage component, wherein data blocks used for the Hadoop compute stack are mapped to a virtual DataNode even if the physical locations of data associated with such DataNode are disparate on different storage resources. When a DataNode is instantiated (i.e. designated as such because it is associated with data relating to the data analysis, or data will be moved thereto), the DataNode software causes the system to scan through files associated with the DataNode, and generate a list of all HDFS data blocks that correspond to each of these files and sends this report to the integration NameNode: this is the Blockreport.

In general, all HDFS communication protocols are layered on top of the TCP/IP protocol. A client establishes a connection to a configurable TCP port on the integration NameNode machine. It talks the ClientProtocol with the NameNode. The DataNodes talk to the NameNode using the DataNode Protocol. In addition, when a compute task runs on a node and needs to read/write data, it speaks to the DataNode using the DataNode Protocol. A Remote Procedure Call (RPC) abstraction wraps both the Client Protocol and the DataNode Protocol. By design, the NameNode never initiates any RPCs. Instead, it only responds to RPC requests issued by DataNodes or clients. Embodiments of the data storage system described herein operate similarly in this regard, as the Hadoop compute stack should be run unmodified on top of storage, and so the application-specific process in the VPU serves up the same HDFS protocol to clients as described above. In contrast, however, embodiments of the instant storage system may respond to NameNode and DataNode RPCs differently in one or more of the following ways: by writing metadata directly to data object store file system instead of using an EditLog and FsImage checkpoint; and by writing file data directly to the data object store file system instead of storing files as a set of individual file blocks on local storage.

Each DataNode in one embodiment may be configured to send a Heartbeat message to the integration NameNode periodically, which is intended to enable the integration NameNode to detect DataNode failure by the absence of a Heartbeat message. The integration NameNode marks DataNodes without recent Heartbeats as dead and does not forward any new IO requests to them and data that was registered to a dead Data Node is not available to HDFS. DataNode death may, in conventional Hadoop implementations, cause the replication factor of some blocks to fall below their specified value. In embodiments of the instantly described system, however, DataNode death does not generally cause the replication factor to drop below their limits since data replication is handled by the underlying distributed object store (although it would be possible to continue to permit the integration NameNode and DataNode implementations provide for replication, as opposes to the data object store).

Unlike conventional Hadoop implementations, in which the NameNode must initiate replication whenever necessary, the integration NameNode in some embodiments hereof permits the data object store file system to initiate replication in accordance with its own performance related requirements (except insofar as the application-specific protocol requires increased replication for its own performance reasons, such as very large files that could use parallel/simultaneous processing for the same file, in which case the integration NameNode or the Hadoop process on the VPU may initiate a request to the data object store file system for increased replication and/or improved storage tiers).

Both conventional and the instantly disclosed data storage system-implemented Hadoop implementations are compatible with cluster rebalancing. The HDFS architecture is compatible with data rebalancing schemes since the data storage system might automatically move data from one DataNode to another if the free space on a DataNode (including the free space of a specific storage tier) falls below a certain threshold. In the event of a sudden high demand for a particular file, a scheme might dynamically create additional replicas and rebalance other data in the cluster. This may happen routinely and/or dynamically on some embodiments of the data storage system for the benefit of the Hadoop compute stack (or the HDFS), or it may happen due to other unrelated processes or data clients using or otherwise associated with the data.

Conventional HDFS client software implements a checksum computation on retrieved data blocks for reasons of data integrity. In general, corruption can occur because of faults in a storage device, network faults, or buggy software, and such corruption is possible in embodiments of the instantly disclosed data storage system. Conventional HDFS client software implements checksum checking on the contents of HDFS files; when a client creates an HDFS file, it computes a checksum of each block of the file and stores these checksums in a separate hidden file in the same HDFS namespace. When a client retrieves file contents it verifies that the data it received from each DataNode matches the checksum stored in the associated checksum file. If not, then the client can opt to retrieve that block from another DataNode that has a replica of that block. In embodiments of the instant disclosure, the integration module may implement a correction of the checksum prior to the above-described matching to account for changes to the data block that occurred due to an change in the data by the data object store file system (or other application-specific process) independent of the Hadoop process in question, and not because of corruption. In some embodiments, this permits the checksum functionality to both avoid corruption but still permit changes “under the feet” of the HDFS. In some embodiments, the checksum may be turned off and HDFS will simply rely on the existing corruption detection and avoidance implemented in the underlying data storage system. Unlike conventional Hadoop implementations, the integration NameNode machine is not a single point of failure for an HDFS cluster because if the integration NameNode machine fails, it may be replicated on other data storage component processing resources.

In some embodiments, snapshots support (i) storing a copy of data at a particular instant of time or (ii) freezing a set of data as it exists at a particular instant of time and then associating new data addresses/storage locations for updates to that data (so that the snapshot remains). The snapshots can be used for application-specific processing, such as the Hadoop compute stack of this example. Another usage of the snapshot feature may be to roll back a corrupted HDFS instance to a previously known good point in time; the snapshot may be used for the files storage at the integration NameNode (i.e. FsImage and EditLog).

In embodiments, a Hadoop client request to create a file sent to the Hadoop process at the VPU may not reach the integration NameNode immediately, and associated file data may be cached into a temporary local file. Application writes (i.e. writes originating from the Hadoop compute stack) are transparently redirected to this temporary local file. When the local file accumulates data worth over one HDFS block size, the application contacts the integration NameNode. The integration NameNode inserts the file name into the HDFS hierarchy and allocates a data block for it somewhere in the data storage system (possibly by selecting a data storage component resource and/or node that meets operational requirements). The integration NameNode responds to the application request with the identity of the DataNode and the destination data block. Then the application flushes the block of data from the local temporary file to the specified DataNode. When a file is closed, the remaining un-flushed data in the temporary local file is transferred to the DataNode. The application then tells the integration NameNode that the file is closed. At this point, the integration NameNode commits the file creation operation into a persistent store. In some embodiments, the block size may be pushed down to data object storage system, particularly if the system already implements the analogous notion of stripe size. In such embodiments, writes are not buffered in temporary files; they are sent to the storage system which allocates a new stripe (block) if necessary. If a write partially fills a stripe, subsequent writes are sent to the stripe until it is full and a new stripe is allocated.

The Hadoop process, and the associated HDFS, running on an instantiated VPU in embodiments of the data storage system can be accessed in many different ways. Natively, HDFS provides a Java API for applications to use. A C language wrapper for this Java API is also available. In addition, an HTTP browser can also be used to browse the files of an HDFS instance; HDFS may also be exposed through the WebDAV protocol. Conventional HDFS allows user data to be organized in the form of files and directories and provides a command line interface called FS shell that lets a user interact with the data in HDFS. These are similarly available when run within VPUs instantiated in embodiments of the instantly disclosed data storage system. The syntax of this command set is similar to other shells (e.g. bash, csh) known to persons skilled in the art. The conventional DFSAdmin command set is used for administering an HDFS cluster and is likewise available when run from within the VPU. A typical HDFS install is configured to expose the HDFS namespace through a configurable connection to the data storage system thus allowing a Hadoop user or client to navigate the HDFS namespace on embodiments hereof and view the contents of its files using a web browser.

In embodiments, space reclamation for deleted data files associated with the Hadoop process may be left to the data storage system to manage the freed up space. However, in some embodiments, a file that is deleted by a user or an application, may not be immediately removed from HDFS (and have associated space reclamation left to the underlying data storage system). Instead, the HDFS first renames it to a file in a /trash directory. The file can be restored quickly as long as it remains in /trash. A file remains in /trash for a configurable amount of time. After the expiry of its life in /trash, the integration NameNode deletes the file from the HDFS namespace. The deletion of a file causes the blocks associated with the file to be freed and released for general use by the data object store. A user can Undelete a file after deleting it as long as it remains in the /trash directory. If a user wants to undelete a file that he/she has deleted, he/she can navigate the /trash directory and retrieve the file. The /trash directory contains only the latest copy of the file that was deleted. The /trash directory is just like any other directory with one special feature: HDFS in general applies specified policies to automatically delete files from this directory. This auto-delete feature, however, may be overridden by the data store object file system.

Although in many embodiments, replication policy is left to the data storage system, the VPU-run Hadoop process may nevertheless increase or reduce the replication factor. When the replication factor of a file is reduced, the integration NameNode may select excess replicas that can be deleted, although in general, it will notify the data object store file system that there excess replicas and, if the excess are not required for general data storage purposes or other applications, the data object store file system may release one or more replicas; it will release the replicas that are not necessary to meet any operational requirements of data storage or other application-specific processing. The next Heartbeat transfers this information to the DataNode. The DataNode then disassociates the corresponding blocks as being a part of the Hadoop processing (although they may of course remain stored in their current location in the data storage component as they may be used or associated with general data storage or other application-specific processes).

In embodiments, Hadoop parallelizes work by scheduling analyses against file chunks spread across nodes the system. If the data object store has stored as whole those files which are being analysed, some pre-processing by the integration module of the data object store may be required to copy them into chunks that the Hadoop scheduler will be able to better use to parallelize the processing of the file. Some embodiments include, implemented by the integration module, a data remapping facility that could allow the overlaying of a file with what looks like separate addressable files or chunks. In some cases, the file may in fact be split up into separate addressable files or chunks, wherein the mapping thereto may be made visible to the data object store file system.

In embodiments, there are provided methods of integrating a data object store file system in a data storage system with an application-specific data access protocol, the application-specific data access protocol being implemented by an application-specific process in a virtualized processing unit in the data storage system, the data storage system comprising one or more data storage components. In one such embodiment, the method comprises the steps of implementing the application-specific process on a virtual processing unit that has been instantiated on one or more of the data storage components (or alternatively on one or more computing devices which are communicably coupled to the data storage system); exposing the application-specific data access protocol as a direct interface to a data object store of the data storage system; permitting application-specific data access protocol requests as direct requests to the data object store file system (including by, in some cases, by translating the application-specific data access protocol requests, if necessary, to requests that may be processed by the data object store file system); and rectifying, to the extent necessary, incompatibilities between the application-specific data access protocol and the underlying data object store file system. Such rectification may become required if data in the data object store which is used by the application-specific process is changed or deleted in the data object store file system (by a data client or another application-specific process, for example) after such processing has begun but before it is complete. In some embodiments, rectification may be necessary if the application-specific protocol makes changes to data in the data object store, and such changes require additional rectification to make such changes visible or compatible with another application-specific process or the data object store file system. Such rectification may involve the use of snapshots to support immutable HDFS file blocks, implementing a checksum correction routine (and/or re-executing any application-specific processing that may have taken place with pre-updated data—although this depends on whether it is appropriate to process data which has been updated after the process has been initiated). In some embodiments, the step of implementing a namespace mapping of storage locations of data objects in the data object store may be optionally implemented specifically for the application-specific protocol in order to ensure that data placement management in the data object store remains accessible to the application-specific protocol.

In embodiments, the data storage system exposes both NFS and HDFS access to the same underlying data objects in the data object store, wherein said data objects are accessed in accordance with a data object store file system. This is in contrast to conventional Hadoop NFS Gateway, which is a software layer that translates NFS protocol requests to HDFS protocol requests, with the underlying file system being HDFS with all of its limitations. The Hadoop NFS Gateway only exposes a subset of NFS functionality; it omits functionality that is not supported by the underlying HDFS file system; for example, it is read and append-only so random writes are not supported in the Hadoop NFS Gateway.

In some embodiments, there is provided a method of implementing application-specific processing in a distributed data storage system, the distributed data storage system comprising a plurality of communicatively coupled data storage components, each data storage component comprising at least one data storage resource and a processor, the plurality of data storage components maintaining a data object store of client data, said client data being stored in said data object store in accordance with a data object store file system, the method comprising the steps: Implementing on a virtualized processing unit an application for application-specific data processing of client data stored on the data object store, said virtualized processing unit being instantiated on at least one of the processors; Accessing client data in the data object store in accordance with an application-specific data access protocol while client data requests to the data object store can be processed by the data object store file system. In some embodiments, the method may further comprise the step of communicating client data changes in the data object store resulting from client data requests to the virtualized processing unit during application-specific data processing of client data. In some embodiments, the method may further comprise the steps of: Implementing client data changes in the data object store resulting from application-specific data requests resulting from the application-specific data processing in the virtualized processing unit. In yet other embodiments, the method may further comprise the step of designating one or more priority-matched processors for instantiating the virtualized processing unit, wherein the priority-matched processors have operational characteristics which correspond to one or more priority characteristics associated with the application. In yet other embodiments, the method may further comprise the step of forwarding application-specific data requests associated with the application directly to the one or more priority-matched processors designated in the designation step. In yet other embodiments, the method may further comprise the step of storing an output of the application on priority-matched data storage resources from the at least one data storage resources. In yet other embodiments, the method may further comprise, to the extent that client data in the data object store has been replicated, the step of selecting a client data replicate that is associated with a priority-matched data storage resource, wherein priority-matched data storage resources have operational characteristics corresponding to priority characteristics of the application. In yet other embodiments, the method may further comprise the step of creating a new replicate of client data accessed by the application-specific data access protocol at a priority-matched data storage resource, the priority-matched data storage resources have operational characteristics of the application.

In some embodiments, there are disclosed methods wherein the application-specific data processing is selected from the group: data analysis, data services, web services, database services, email services, peer-to-peer file sharing, garbage collection services, deduplication, backup services, archival services, and e-discovery services. In some such methods, the data analysis is a Hadoop-based application. In some embodiments, the result of application-specific data processing is an input for a second application-specific data processing. In some methods, the application-specific data processing is implemented by the data storage system for data services relating to the data object store.

In some embodiments, there are disclosed data storage devices for implementing application-specific data processing of stored client data in a distributed data storage system, the data storage component comprising: at least one data storage resource; a processor, and a communications interface for network communication with at least one of the following: one or more clients and other data storage devices; wherein the data storage device maintains at least a portion of client data in a data object store, said client data being stored in said data object store in accordance with a data object store file system; and wherein the data storage device is configured to instantiate thereon a virtualized processing unit, the virtualized processing unit configured to implement application-specific data processing of client data in the data object store, said client data object store accessible by said virtualized processing unit in accordance with an application-specific data storage access protocol, wherein client data requests to the data object store can be processed by the data object store file system during application-specific data processing.

In another embodiment, there is disclosed a method of integrating a data object store file system in a data storage system with an application-specific data access protocol, the application-specific data access protocol being implemented by an application-specific process in a virtualized processing unit in the data storage system, the data storage system comprising a plurality of data storage components, the method comprising the steps: Sending data requests to a data object store in the data storage system in accordance with the application-specific data access protocol; Selecting for each data request a candidate location from least-loaded of said plurality data storage component, said candidate location being associated with said data request; Associating said data requests with respective candidate locations for responding to data requests associated with the application-specific protocol. In some embodiments, there are disclosed methods that include the steps of dividing into a plurality of chunks a file associated with data requests sent in accordance with the application-specific data access protocol; and designating separate locations for each chunk. In some embodiments, there are disclosed methods that including the step of moving a copy of at least one chunk to a further location in the data storage system, wherein the further location may be included as a candidate location for responding to data requests associated with the application-specific protocol.

In embodiments of the instantly disclosed subject matter, there is an integration of compute-level processing with data storage-level events and activities through the use of VPUs that are instantiated within or with direct access to data storage. This close integration causes close a binding of computational activities with data storage. In some embodiments, this permits the encapsulation of specific computational activity specific types of data storage (or specific types of data storage events). In some embodiments, this may be accomplished by “eventing” or “triggering” activities that are associated directly with storage. A data-storage level event may trigger the instantiation of a VPU to carry out a specific compute function, or it may cause an existing VPU to carry out a specific compute function. By associating compute directly to storage in this manner, it reduces and simplifies compute or processing latency on that data. The compute-function (and/or the VPU carrying such compute-functions) is associated directly with the data itself, through the triggering based on storage-level events. As such, processing is carried out immediately upon a storage-level event, as opposed to being queried by an applicable entity. As an illustrative example, consider a VPU-based web server instantiated within the data storage system that uses data stored therein to generate a web page; upon (as non-limiting triggering examples) the addition of a particular type of data, or of data at a particular location, the data storage system triggers computation by the VPU-based web server to update the web page information. In this example, the VPU-based web server may cause an updated file or web page data to be stored elsewhere in the data storage system as HTML, or it may be rendered accessible by web clients as HTML from the data object store file system. The VPU-based web server may, in this example, expose data to a web client as HTML by using an application-specific data access protocol (in this case HTML) from the data object file system, or it may generate an HTML-based file for storage in the data storage system which may then also be accessible by the application-specific data access protocol. More generally, embodiments hereof may support the automatic activation of computation, within VPU directly associated with live data in the data storage system, upon storage-level events. As such, any arbitrary compute functionalities can be bound to data and date event. Such data events may include, as a set of non-limiting examples, the addition or deletion of data, the addition or removal of data nodes, the updating of specific data or data types. As such, compute functions have inherently increased locality with respect to the associated data (both relationally and temporally); compute can occur “close” to where the data is located and “close” to the time when the data is updated. Compute functions are also inherently scalable; compute functions are tied to data storage, which can always be scaled. The execution of VPUs, including either or both of the instantiation of a specific VPU or a given compute function or functions within a VPU, is triggered by events. Those events may be temporal (time of day), storage related (file creation, deletion, modification), data related (type of data, traffic-based, priority-based, user or user-type, source), or environmental (out of space, addition of new nodes, resource consumption)

Another advantage of associating compute events directly with data storage-level events is that rules-based computation can be implemented upon the occurrence of data storage events. A data storage-level event can be any change to storage or the storage system, including but not limited to the following illustrative examples: a read, a write, an update, a deletion, an increase or decrease in storage (through the addition or removal of resources, or a failure of a resource or a previously failed resource coming back online), an increase or decrease in traffic, or an anomalous event (e.g. an attempted, suspected, or actual security breach). By associating compute events with such events, a policy can be implemented. Consider the following examples: (i) upon a write request to a given storage location or directory, the data storage system may trigger a VPU to assess if content violates a permitted use, such as Al to determine if such content constitutes pornography or copyright violation, and if the content does violate a permitted use policy, then storage is not permitted; (ii) upon a read request of a specific type of data (e.g. personal data), a write of another type of data may not be permitted (e.g. SIN number); or (iii) upon a read request from a certain type of user and/or during times of high workload, read response may return a different subset of data (e.g. only a reduced number of data from a video data object, thereby providing video transcoding to provide higher or lower quality—without generating a different video file; another example may include returning images of higher or lower quality, or in grayscale only instead of colour—again, without creating a new file but rather by only returning the stored data needed to generate the altered image associated with the given user type or network conditions at time of read).

In some embodiments, the compute event and the data storage-level event may be synchronous or asynchronous with each other. Synchronous activation means that VPU execution (instantiation thereof and/or compute thereon) must happen inline, or contemporaneously, with storage-level requests. If a VPU, or a VPU-based compute function, is registered to run on file creation, it is allowed to run, to completion before the file creation is processed by the underlying storage; the VPU has the option to fail, amend, or otherwise manage the storage-level request. This is useful as a mechanism for creating access control policies (e.g. you can't create a file that contains social insurance numbers or profanity; requests from certain users, possibly at certain times, must be stored in a certain manner or in a certain location). It is also useful as a mechanism for implementing storage extensions such as snapshots (in the case of synchronous extensions on the write processing path) or other administrative events (e.g. triggering garbage collection after a specific number of data storage-events and/or when conditions relating to data storage-events reach a pre-determined state. Asynchronous events, on the other hand, are guaranteed to run at some time later, but do not interfere with the initial storage request. Asynchronous requests are useful general data processing, such as (but not limited to, summarization, post-storage event analysis, or system administration or optimization, in which the outcome of the VPU, though triggered by such event, is independent from the outcome of the original activation event.

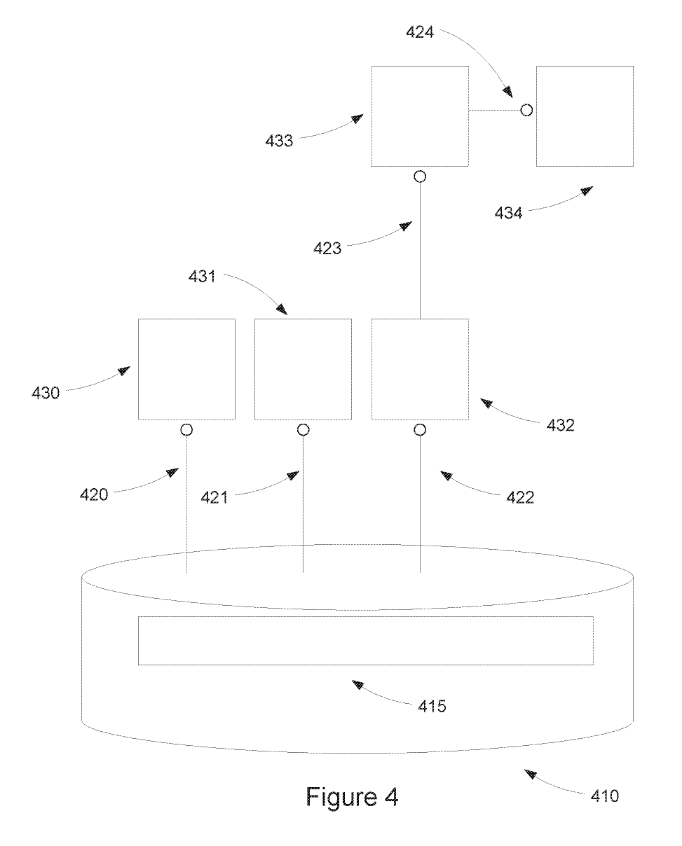

In some embodiments, the VPU execution may result in new data being created, which may in turn result in the activation of additional VPUs on the new data. In this matter, VPUs may be used to “chain” together workflows. In some cases, a VPU may present, or expose, data in accordance with another data-access protocol that can be used for another VPU. Referring to exemplary FIG. 4, a conceptual representation of this embodiment is shown. The data object store 410, made available by the distributed data storage system (not shown), stores data in accordance with the data object store file system 415. The data object store file system may manage storage locations, handle data requests, implement administrative data functions, tracks data storage locations, creates and maintains consistency in duplicates, etc. The distributed data storage system (or in some embodiments the data object store file system 410) exposes or allows data therein to be interacted by VPUs 430, 431, 432 via application-specific data access protocols 420, 421, 422. For example, VPU 430 can interact with the data object store 410 and/or the data object store file system 415 using NFS as the application-specific data access protocol 420; VPU 431 can interact with the data object store 410 and/or the data object store file system 415 using HDFS (i.e. Hadoop file system) as the application-specific data access protocol 421; and VPU 433 can interact with the data object store 410 and/or the data object store file system 415 using Amazon S3 as the application-specific data access protocol 422. In each case, the data storage system may facilitate the connection between file systems by implementing an API on the storage system at the data storage components, in an integration module (not shown), or in the applicable VPU. In some cases, each VPU may also provide for a connection with another application-specific data access protocol. For example, VPU 433 presents connectivity with VPU 434 by permitting access (using, in some cases an API running on one of the connected VPUs) by another application-specific data access protocol 424, in this example, HTML. As such, by storing data in a specific location or node (or having some other identifiable characteristic), it can be automatically presented in accordance with and for an Amazon S3 file system and/or application, and a subset of that information can be presented as HTML, and thereby exposed to, and/or usable by, a web server (possibly running as VPU 433) so it can provide a web page from that information. In some embodiments, this nested or chained presentation can be further extended to another VPU 434 via yet another application-specific data access protocol 424.

In some embodiments, VPUs may be long-running services, and they may present new services associated with the data on the network. For example, a VPU may make a subdirectory of data available to users over a new storage protocol that is not supported by the underlying storage system. Alternatively, the VPU may present a web-based report that summarizes the data that it has processed. In this regard, VPUs allow the storage system to be extended to offer new services, views, and APIs on to the stored data.

While the present disclosure describes various exemplary embodiments, the disclosure is not so limited. To the contrary, the disclosure is intended to cover various modifications and equivalent arrangements included within the general scope of the present disclosure.

We claim:

1. A distributed data storage system for implementing application-specific data processing of stored client data, the data storage system comprising:
a plurality of communicatively coupled data storage components, each data storage component comprising at least one data storage resource and a processor, the plurality of data storage components maintaining a data object store of client data, said client data being stored in said data object store in accordance with a data object store file system; and
a virtualized processing unit instantiated to implement application-specific data processing of said client data stored on the data object store, said client data object store accessible by said virtualized processing unit in accordance with an application-specific data storage access protocol;
wherein client data requests to the data object store are concurrently processed by the data object store file system during said application-specific data processing.

2. The system of claim 1, further comprising an integration module communicating client data changes in the data object store resulting from said client data requests to the virtualized processing unit during said application-specific data processing of said client data.

3. The system of claim 1, wherein the data object store file system implements client data changes in the data object store resulting from application-specific data requests resulting from said application-specific data processing in the virtualized processing unit.

4. The system of any one of claims 1 to 3, wherein said application-specific data processing is executed on a snapshot of the client data in the data object store.

5. The system of any one of claims 1 to 4, wherein said application-specific data processing comprises at least one of data analysis, web services, database services, email services, data services, peer-to-peer file sharing, garbage collection services, deduplication, backup services, archival services, and e-discovery services.

6. The system of any one of claims 1 to 4, wherein said application-specific data processing is a Hadoop-based application.

7. The system of claim 5, wherein a result of said application-specific data processing is an input for a subsequent application-specific data processing.

8. The system of claim 5, wherein said application-specific data processing is implemented by the data storage system for data services relating to the data object store.

9. The system of any one of claims 1 to 8, wherein the data storage system further comprises a data switching component interfacing the data storage system to clients, the data switching component having access to a data object mapping service indicating storage locations of data objects in the data object store.

10. The system of claim 9, wherein the data switching component directs the client data requests directly to given data storage components having data stored thereon relating to said client data requests.

11. The data storage system of any one of claims 1 to 10, wherein the data storage system associates one or more priority characteristics with any one or more of: a given application-specific data processing process, a given client data request, a given data storage process, given application-specific data, and given client data.

12. The data storage system of claim 11, wherein the virtualized processing unit can be instantiated on one or more said processor having operational characteristics meeting one or more priority characteristics associated with at least one of: the virtualized processing unit and a corresponding data storage component.

13. The data storage system of any one of claims 1 to 12, wherein the virtualized processing unit comprises a container, a jail, a virtual machine, a docker, a kubernet, or a fleet of the foregoing.

14. The data storage system of any one of claims 1 to 13, wherein the application-specific data access protocol comprises at least one of NFS, HDFS, iSCSI, Fibre Channel Protocol, HTTP object storage access protocols, Amazon Web Services S3, OpenStack SWIFT, Google Storage Service, Microsoft Azure Storage Services, OpenStack SWIFT, Google Storage Service, Microsoft Azure Storage Services Blob Service, a NoSQL API, MongoDB, Riak, CouchDB, and Cassandra.

15. The data storage system of any one of claims 1 to 14, wherein application-specific data requests resulting from the application-specific data processing in the virtualized processing unit are stored in data storage resources with operational characteristics associated with reduced priority.

16. The data storage system of any one of claims 1 to 15, wherein said client data object store is accessible by said virtualized processing unit in accordance with a plurality of application-specific data storage access protocols.

17. The data storage system of any one of claims 1 to 16, wherein a given process on said virtualized processing unit is automatically triggered by a data storage event.

18. The data storage system of claim 17, wherein the given process and the data storage event are one of: synchronous and asynchronous.

19. A method of implementing application-specific processing in a distributed data storage system, the distributed data storage system comprising a plurality of communicatively coupled data storage components, each data storage component comprising at least one data storage resource and a processor, the plurality of data storage components maintaining a data object store of client data, said client data being stored in said data object store in accordance with a data object store file system, the method comprising:
implementing on a virtualized processing unit an application for application-specific data processing of client data stored on the data object store, said virtualized processing unit, upon being instantiated, is accessible by at least one said processors; and
accessing client data in the data object store in accordance with an application-specific data access protocol while client data requests to the data object store are concurrently processed by the data object store file system.

20. The method of claim 19, wherein the method further comprises communicating client data changes in the data object store resulting from client data requests to the virtualized processing unit during application-specific data processing of client data.

21. The method of claim 19 or claim 20, wherein the method further comprises implementing client data changes in the data object store resulting from application-specific data requests resulting from the application-specific data processing in the virtualized processing unit.

22. The method of claim 19, wherein the method further comprises designating one or more priority-matched processors for instantiating the virtualized processing unit, wherein the priority-matched processors have operational characteristics which correspond to one or more priority characteristics associated with the application.

23. The method of claim 22, wherein the method further comprises forwarding application-specific data requests associated with the application directly to the one or more priority-matched processors designated in the designating step.

24. The method of claim 19, wherein the method further comprises: storing an output of the application on priority-matched data storage resources from the at least one data storage resources.

25. The method of claim 19, wherein the method further comprises, to the extent that client data in the data object store has been replicated, selecting a client data replicate that is associated with a priority-matched data storage resource, wherein priority-matched data storage resources have operational characteristics corresponding to priority characteristics of the application.

26. The method of claim 19, wherein the method further comprises creating a new replicate of client data accessed by the application-specific data access protocol at a priority-matched data storage resource, the priority-matched data storage resources have operational characteristics of the application.

27. The method of claim 19, wherein the application-specific data processing comprises data analysis, data services, web services, database services, email services, peer-to-peer file sharing, garbage collection services, deduplication, backup services, archival services, or e-discovery services.

28. The method of claim 19, wherein the application-specific data processing is a Hadoop-based data analysis.

29. The method of claim 19, wherein a result of the application-specific data processing is an input for a subsequent application-specific data processing.

30. The method of claim 19, wherein the application-specific data processing is implemented by the data storage system for data services relating to the data object store.

31. The method of any one of claims 19 to 30, wherein said client data object store is accessible by said virtualized processing unit in accordance with a plurality of application-specific data storage access protocols.

32. The method of any one of claims 19 to 31, wherein a given process on said virtualized processing unit is automatically triggered by a data storage event.

33. The method of claim 32, wherein the given process and the data storage event are one of: synchronous and asynchronous.

34. A data storage device for implementing application-specific data processing of stored client data in a distributed data storage system, the data storage component comprising:
at least one data storage resource;
a processor; and
a communications interface for network communication with at least one of the following: one or more clients and other data storage devices;
wherein the data storage device maintains at least a portion of client data in a data object store, said client data being stored in said data object store in accordance with a data object store file system; and
wherein the data storage device is configured to instantiate thereon a virtualized processing unit, the virtualized processing unit configured to implement application-specific data processing of client data in the data object store, said client data object store accessible by said virtualized processing unit in accordance with an application-specific data storage access protocol, wherein client data requests to the data object store can be processed by the data object store file system during application-specific data processing.

35. A method of integrating a data object store file system in a data storage system with an application-specific data access protocol, the application-specific data access protocol being implemented by an application-specific process in a virtualized processing unit in the data storage system, the data storage system comprising a plurality of data storage components, the method comprising:
receiving data requests sent in accordance with the application-specific data access protocol;
determining locations in the plurality of data storage components for data responsive to said data requests;
selecting for each data request a candidate location from least-loaded of said plurality data storage component; and
associating said data requests with respective candidate locations for responding to data requests associated with the application-specific protocol.

36. The method of claim 35, wherein the method further comprises:
dividing into a plurality of chunks a file associated with data requests sent in accordance with the application-specific data access protocol; and
designating separate locations for each chunk.

37. The method of claim 36, wherein the method further comprises: moving a copy of at least one chunk to a further location in the data storage system, wherein the further location may be included as a one of the candidate locations for responding to data requests associated with the application-specific protocol.
